(19) United States
(12) Patent Application Publication
(10) Pub. No.: US 2024/0359683 A1
(43) Pub. Date: Oct. 31, 2024

(54) PREVENTION OF PEDESTRIAN ACCIDENTS AT PEDESTRIAN CROSSINGS WHEN A REAR-END COLLISION IS DETECTED

(71) Applicant: Volvo Car Corporation, Göteborg (SE)

(72) Inventors: Oswaldo Perez Barrera, Gothenburg (SE); Anders Lennartsson, Gothenburg (SE)

(21) Appl. No.: 18/308,001

(22) Filed: Apr. 27, 2023

(51) Int. Cl. B60W 30/09; B60W 30/095; B60W 30/18; B60W 40/06; B60W 50/00; G06V 20/58; G06V 40/16

(52) U.S. Cl. CPC B60W 30/09; B60W 30/0956; B60W 30/18163; B60W 40/06; B60W 50/0097; G06V 20/58; G06V 40/172; B60W 2554/4026; B60W 2554/4029; B60W 2554/4041; B60W 2554/4045; B60W 2554/80; B60W 2556/45

(57) ABSTRACT

Prevention of pedestrian accidents at pedestrian crossings (e.g., using a computerized tool) is enabled. For example, a method can comprising: determining, by a system comprising a processor and based on a first location of a first vehicle, a second location of a second vehicle, and a speed differential between the first vehicle and the second vehicle, whether a first collision between the first vehicle and the second vehicle is threshold likely to occur, determining, by the system and based on a third location of a pedestrian and the first collision being determined to be threshold likely to occur, whether a second collision between the first vehicle and the pedestrian is threshold likely to occur, and based on the second collision being determined to be threshold likely to occur, facilitating, by the system, an impact mitigation action determined to mitigate the second collision.

### TECHNICAL FIELD

The disclosed subject matter relates to vehicles (e.g., transportation vehicles) and, more particularly, to prevention of pedestrian accidents at pedestrian crossings as a result of a rear-end collision between two or more vehicles.

### BACKGROUND

When a pedestrian is crossing a street (e.g., at a pedestrian crossing), and a rear-end type collision occurs between two vehicles, a leading vehicle can be pushed into the pedestrian by a trailing vehicle (e.g., the vehicle that causes the rear-end collision). Frequently, a pedestrian is unaware of the potential collision between the trailing vehicle and the leading vehicle. Such a lack of awareness, on the part of the pedestrian, can result in the pedestrian becoming involved in the accident, potentially resulting in injury to the pedestrian.

The above-described background relating to vehicle and pedestrian safety is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate vehicle passenger space identification and/or contact mitigation are described.

As alluded to above, vehicle safety systems can be improved in various ways, and various embodiments are described herein to this end and/or other ends.

According to an embodiment, a system can comprise a memory that stores computer executable components, and a processor that executes the computer executable components stored in the memory, wherein the computer executable components can comprise: an impact determination component that determines, based on a first location of a first vehicle, a second location of a second vehicle, and a speed differential between the first vehicle and the second vehicle, whether a first collision between the first vehicle and the second vehicle is threshold likely to occur, and determines, based on a third location of a pedestrian and the first collision being determined to be threshold likely to occur, whether a second collision between the first vehicle and the pedestrian is threshold likely to occur, and an impact mitigation component that, based on the second collision being determined to be threshold likely to occur, facilitates an impact mitigation action determined to mitigate the second collision.

According to another embodiment, a non-transitory machine-readable medium can comprise executable instructions that, when executed by a processor, facilitate performance of operations, comprising: determining, based on a first location of a first vehicle, a second location of a second vehicle, and a speed differential between the first vehicle and the second vehicle, whether a first collision between the first vehicle and the second vehicle is threshold likely to occur, determining, based on a third location of a pedestrian and the first collision being determined to be threshold likely to occur, whether a second collision between the first vehicle and the pedestrian is threshold likely to occur, and based on the second collision being determined to be threshold likely to occur, facilitating an impact mitigation action determined to mitigate the second collision.

According to yet another embodiment, a method can comprise: determining, by a system comprising a processor and based on a first location of a first vehicle, a second location of a second vehicle, and a speed differential between the first vehicle and the second vehicle, whether a first collision between the first vehicle and the second vehicle is threshold likely to occur, determining, by the system and based on a third location of a pedestrian and the first collision being determined to be threshold likely to occur, whether a second collision between the first vehicle and the pedestrian is threshold likely to occur, and based on the second collision being determined to be threshold likely to occur, facilitating, by the system, an impact mitigation action determined to mitigate the second collision.

### BRIEF DESCRIPTION OF DRAWINGS

FIG. 1 illustrates a block diagram of an exemplary system in accordance with one or more embodiments described herein.

FIG. 2 illustrates a block diagram of example, non-limiting computer executable components in accordance with one or more embodiments described herein.

FIG. 3 illustrates a block diagram of example, non-limiting vehicle electronic systems/devices in accordance with one or more embodiments described herein.

FIG. 4 illustrates a block diagram of example, non-limiting external devices in accordance with one or more embodiments described herein.

FIG. 5 illustrates an example, non-limiting scenario in accordance with one or more embodiments described herein.

FIG. 6 illustrates an example, non-limiting scenario in accordance with one or more embodiments described herein.

FIG. 7 illustrates an example, non-limiting scenario in accordance with one or more embodiments described herein.

FIG. 8 illustrates an example, non-limiting scenario in accordance with one or more embodiments described herein.

FIG. 9 illustrates an example, non-limiting scenario in accordance with one or more embodiments described herein.

FIG. 10 illustrates an example, non-limiting scenario in accordance with one or more embodiments described herein.

FIG. 11 illustrates an example, non-limiting scenario in accordance with one or more embodiments described herein.

FIG. 12 illustrates an example, non-limiting scenario in accordance with one or more embodiments described herein.

FIG. 13 illustrates an example, non-limiting scenario in accordance with one or more embodiments described herein.

FIGS. 14A-14C illustrate example, non-limiting scenarios in accordance with one or more embodiments described herein.

FIG. 15 illustrates an example, non-limiting scenario in accordance with one or more embodiments described herein.

FIG. 16 illustrates an example, non-limiting scenario in accordance with one or more embodiments described herein.

FIG. 17 illustrates an example, non-limiting scenario in accordance with one or more embodiments described herein.

FIG. 18 illustrates an example, non-limiting scenario in accordance with one or more embodiments described herein.

FIG. 19 illustrates an example, non-limiting scenario in accordance with one or more embodiments described herein.

FIG. 20 illustrates an example, non-limiting scenario in accordance with one or more embodiments described herein.

FIG. 21 illustrates an example, non-limiting scenario in accordance with one or more embodiments described herein.

FIG. 22 illustrates an example, non-limiting scenario in accordance with one or more embodiments described herein.

FIG. 23 illustrates a block flow diagram for a process associated with vehicle safety systems in accordance with one or more embodiments described herein.

FIG. 24 is an example, non-limiting computing environment in which one or more embodiments described herein can be implemented.

FIG. 25 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments the described herein.

The computer processing systems, computer-implemented methods, apparatus and/or computer program products described herein employ hardware and/or software to solve problems that are highly technical in nature (e.g., identify vehicle passenger space and/or mitigate contact), that are not abstract and cannot be performed as a set of mental acts by a human.

In various embodiments described herein, when near a pedestrian crossing, a vehicle herein (e.g., an autonomous vehicle or a semi-autonomous vehicle) can detect an imminent rear-end collision before it occurs, and attempt to warn applicable pedestrian(s). In some implementations, based on the pedestrian's location and/or behavior, the vehicle can attempt to avoid the rear-end collision by moving (e.g., forward or perform a lane change). In various embodiments described herein, a vehicle can warn pedestrians before a collision happens, and if the pedestrians are far away enough from the vehicle, the vehicle can attempt to avoid the rear-end collision entirely. Even if the rear-end collision still occurs, the risk to nearby pedestrians can be reduced, thus increasing safety.

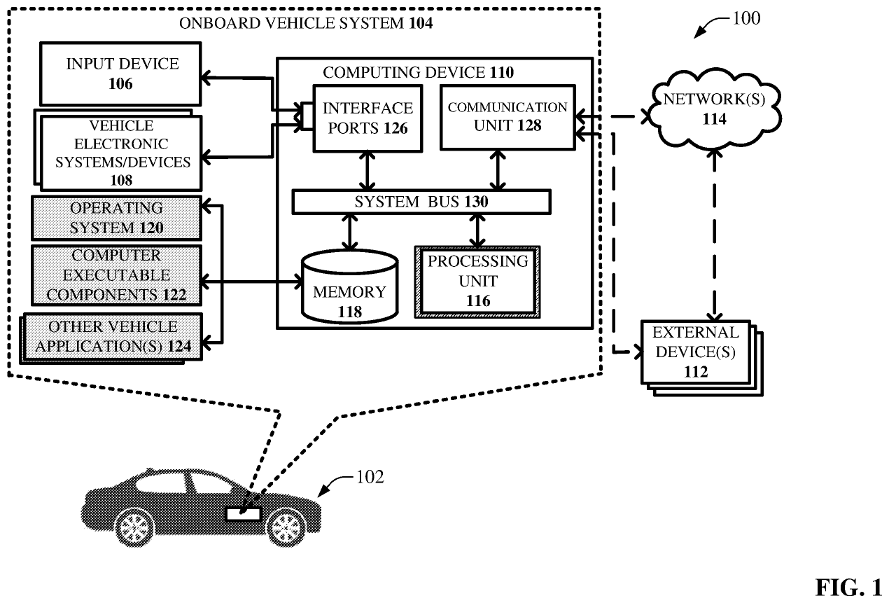

Turning now to FIG. 1, there is illustrated an example, non-limiting system 100 in accordance with one or more embodiments herein. System 100 can comprise a computerized tool, which can be configured to perform various operations relating to prevention of pedestrian accidents (e.g., at pedestrian crossings or in a street). In accordance with various exemplary embodiments, system 100 can be deployed on or within a vehicle 102, (e.g., an automobile, as shown in FIG. 1). Although FIG. 1 depicts the vehicle 102 as an automobile, the architecture of the system 100 is not so limited. For instance, the system 100 described herein can be implemented with a variety of types of vehicles 102. Example vehicles 102 that can incorporate the exemplary system 100 can include, but are not limited to: automobiles (e.g., autonomous vehicles or semi-autonomous vehicles), airplanes, trains, motorcycles, carts, trucks, semi-trucks, buses, boats, recreational vehicles, helicopters, jets, electric scooters, electric bicycles, a combination thereof, and/or the like. It is additionally noted that the system 100 can be implemented in a variety of types of automobiles, such as battery electric vehicles, hybrid vehicles, plug-in hybrid vehicles, internal combustion engine vehicles, or other suitable types of vehicles.

As shown in FIG. 1, the system 100 can comprise one or more onboard vehicle systems 104, which can comprise one or more input devices 106, one or more other vehicle electronic systems and/or devices 108, and/or one or more computing devices 110. Additionally, the system 100 can comprise one or more external devices 112 that can be communicatively and/or operatively coupled to the one or more computing devices 110 of the one or more onboard vehicle systems 104 either via one or more networks 114 and/or a direct electrical connection (e.g., as shown in FIG. 1). In various embodiments, one or more of the onboard vehicle system 104, input devices 106, vehicle electronic systems and/or devices 108, computing devices 110, external devices 112, and/or networks 114 can be communicatively or operably coupled (e.g., over a bus or wireless network) to one another to perform one or more functions of the system 100.

The one or more input devices 106 can display one or more interactive graphic entity interfaces (“GUIs”) that facilitate accessing and/or controlling various functions and/or application of the vehicle 102. The one or more input devices 106 can display one or more interactive GUIs that facilitate accessing and/or controlling various functions and/or applications. The one or more input devices 106 can comprise one or more computerized devices, which can include, but are not limited to: personal computers, desktop computers, laptop computers, cellular telephones (e.g., smartphones or mobile devices), computerized tablets (e.g., comprising a processor), smart watches, keyboards, touchscreens, mice, a combination thereof, and/or the like. An entity or user of the system 100 can utilize the one or more input devices 106 to input data into the system 100. Additionally, the one or more input devices 106 can comprise one or more displays that can present one or more outputs generated by the system 100 to an entity. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

For example, the one or more input devices 106 can comprise a touchscreen that can present one or more graphical touch controls that can respectively correspond to a control for a function of the vehicle 102, an application, a function of the application, interactive data, a hyperlink to data, and the like, wherein selection and/or interaction with the graphical touch control via touch activates the corresponding functionality. For instance, one or more GUIs displayed on the one or more input devices 106 can include selectable graphical elements, such as buttons or bars corresponding to a vehicle navigation application, a media application, a phone application, a back-up camera function, a car settings function, a parking assist function, and/or the like. In some implementations, selection of a button or bar corresponding to an application or function can result in the generation of a new window or GUI comprising additional selectable icons or widgets associated with the selected application. For example, selection of one or more selectable options herein can result in generation of a new GUI or window that includes additional buttons or widgets with one or more selectable options. The type and appearance of the controls can vary. For example, the graphical touch controls can include icons, symbols, widgets, windows, tabs, text, images, a combination thereof, and/or the like.

The one or more input devices 106 can comprise suitable hardware that registers input events in response to touch (e.g., by a finger, stylus, gloved hand, pen, etc.). In some implementations, the one or more input devices 106 can detect the position of an object (e.g., by a finger, stylus, gloved hand, pen, etc.) over the one or more input devices 106 within close proximity (e.g., a few centimeters) to touchscreen without the object touching the screen. As used herein, unless otherwise specified, reference to “on the touchscreen” refers to contact between an object (e.g., an entity's finger) and the one or more input devices 106 while reference to “over the touchscreen” refers to positioning of an object within close proximity to the touchscreen (e.g., a defined distance away from the touchscreen) yet not contacting the touchscreen.

The type of the input devices 106 can vary and can include, but is not limited to: a resistive touchscreen, a surface capacitive touchscreen, a projected capacitive touchscreen, a surface acoustic wave touchscreen, and an infrared touchscreen. In various embodiments, the one or more input devices 106 can be positioned on the dashboard of the vehicle 102, such as on or within the center stack or center console of the dashboard. However, the position of the one or more input devices 106 within the vehicle 102 can vary.

The one or more other vehicle electronic systems and/or devices 108 can include one or more additional devices and/or systems (e.g., in addition to the one or more input devices 106 and/or computing devices 110) of the vehicle 102 that can be controlled based at least in part on commands issued by the one or more computing devices 110 (e.g., via one or more processing units 116) and/or commands issued by the one or more external devices 112 communicatively coupled thereto. For example, the one or more other vehicle electronic systems and/or devices 108 can comprise: seat motors, seatbelt system(s), airbag system(s), display(s), infotainment system(s), speaker(s), a media system (e.g., audio and/or video), a back-up camera system, a heating, ventilation, and air conditioning (“HVAC”) system, a lighting system, a cruise control system, a power locking system, a navigation system, an autonomous driving system, a vehicle sensor system, telecommunications system, a combination thereof, and/or the like. Other example other vehicle electronic systems and/or devices 108 can comprise one or more sensors, which can comprise distance sensors, seats, seat position sensor(s), collision sensor(s), odometers, altimeters, speedometers, accelerometers, engine features and/or components, fuel meters, flow meters, cameras (e.g., digital cameras, heat cameras, infrared cameras, and/or the like), lasers, radar systems, lidar systems, microphones, vibration meters, moisture sensors, thermometers, seatbelt sensors, wheel speed sensors, a combination thereof, and/or the like. For instance, a speedometer of the vehicle 102 can detect the vehicle's 102 traveling speed. Further, the one or more sensors can detect and/or measure one or more conditions outside the vehicle 102, such as: whether the vehicle 102 is traveling through a rainy environment, whether the vehicle 102 is traveling through winter conditions (e.g., snowy and/or icy conditions), whether the vehicle 102 is traveling through very hot conditions (e.g., desert conditions), and/or the like. Example navigational information can include, but is not limited to: the destination of the vehicle 102, the position of the vehicle 102, the type of vehicle 102, the speed of the vehicle 102, environmental conditions surrounding the vehicle 102, the planned route of the vehicle 102, traffic conditions expected to be encountered by the vehicle 102, operational status of the vehicle 102, a combination thereof, and/or the like.

The one or more computing devices 110 can facilitate executing and controlling one or more operations of the vehicle 102, including one or more operations of the one or more input devices 106, and the one or more other vehicle electronic systems/devices 108 using machine-executable instructions. In this regard, embodiments of system 100 and other systems described herein can include one or more machine-executable components embodied within one or more machines (e.g., embodied in one or more computer readable storage media associated with one or more machines, such as computing device 110). Such components, when executed by the one or more machines (e.g., processors, computers, virtual machines, etc.) can cause the one or more machines to perform the operations described.

For example, the one or more computing devices 110 can include or be operatively coupled to at least one memory 118 and/or at least one processing unit 116. The one or more processing units 116 can be any of various available processors. For example, dual microprocessors and other multiprocessor architectures also can be employed as the processing unit 116. In various embodiments, the at least one memory 118 can store software instructions embodied as functions and/or applications that when executed by the at least one processing unit 116, facilitate performance of operations defined by the software instruction. In the embodiment shown, these software instructions can include one or more operating system 120, one or more computer executable components 122, and/or one or more other vehicle applications 124. For example, the one or more operating systems 120 can act to control and/or allocate resources of the one or more computing devices 110. It is to be appreciated that the claimed subject matter can be implemented with various operating systems or combinations of operating systems.

The one or more computer executable components 122 and/or the one or more other vehicle applications 124 can take advantage of the management of resources by the one or more operating systems 120 through program modules and program data also stored in the one or more memories 118. The one or more computer executable components 122 can provide various features and/or functionalities that can facilitate prevention of pedestrian accidents herein. Example, other vehicle applications 124 can include, but are not limited to: a navigation application, a media player application, a phone application, a vehicle settings application, a parking assistance application, an emergency roadside assistance application, a combination thereof, and/or the like. The features and functionalities of the one or more computer executable components 122 are discussed in greater detail infra.

The one or more computing devices 110 can further include one or more interface ports 126, one or more communication units 128, and a system bus 130 that can communicatively couple the various features of the one or more computing devices 110 (e.g., the one or more interface ports 126, the one or more communication units 128, the one or more memories 118, and/or the one or more processing units 116). The one or more interface ports 126 can connect the one or more input devices 106 (and other potential devices) and the one or more other vehicle electronic systems/devices 108 to the one or more computing devices 110. For example, the one or more interface ports 126 can include, a serial port, a parallel port, a game port, a universal serial bus (“USB”) and the like.

The one or more communication units 128 can include suitable hardware and/or software that can facilitate connecting one or more external devices 112 to the one or more computing devices 110 (e.g., via a wireless connection and/or a wired connection). For example, the one or more communication units 128 can be operatively coupled to the one or more external devices 112 via one or more networks 114. The one or more networks 114 can include wired and/or wireless networks, including but not limited to, a personal area network (“PAN”), a local area network (“LAN”), a cellular network, a wide area network (“WAN”, e.g., the Internet), and the like. For example, the one or more external devices 112 can communicate with the one or more computing devices 110 (and vice versa) using virtually any desired wired or wireless technology, including but not limited to: wireless fidelity (“Wi-Fi”), global system for mobile communications (“GSM”), universal mobile telecommunications system (“UMTS”), worldwide interoperability for microwave access (“WiMAX”), enhanced general packet radio service (enhanced “GPRS”), fifth generation (“5G”) communication system, sixth generation (“6G”) communication system, third generation partnership project (“3GPP”) long term evolution (“LTE”), third generation partnership project 2 (“3GPP2”) ultra-mobile broadband (“UMB”), high speed packet access (“HSPA”), Zigbee and other 802.XX wireless technologies and/or legacy telecommunication technologies, near field communication (“NFC”) technology, BLUETOOTH®, Session Initiation Protocol (“SIP”), ZIGBEE®, RF4CE protocol, WirelessHART protocol, 6LoWPAN (IPv6 over Low power Wireless Area Networks), Z-Wave, an ANT, an ultra-wideband (“UWB”) standard protocol, and/or other proprietary and non-proprietary communication protocols. In this regard, the one or more communication units 128 can include software, hardware, or a combination of software and hardware that is configured to facilitate wired and/or wireless communication between the one or more computing devices 110 and the one or more external devices 112. While the one or more communication units 128 are shown for illustrative clarity as a separate unit that is not stored within memory 118, it is to be appreciated that one or more (software) components of the communication unit can be stored in memory 118 and include computer executable components.

The one or more external devices 112 can include any suitable computing device comprising a display and input device (e.g., a touchscreen) that can communicate with the one or more computing devices 110 comprised within the onboard vehicle system 104 and interface with the one or more computer executable components 122 (e.g., using a suitable application program interface (“API”)). For example, the one or more external devices 112 can include, but are not limited to: a mobile phone, a smartphone, a tablet, a personal computer (“PC”), a digital assistant (“PDA”), a heads-up display (“HUD”), virtual reality (“VR”) headset, an augmented reality (“AR”) headset, or another type of wearable computing device, a desktop computer, a laptop computer, a computer tablet, a combination thereof, and the like.

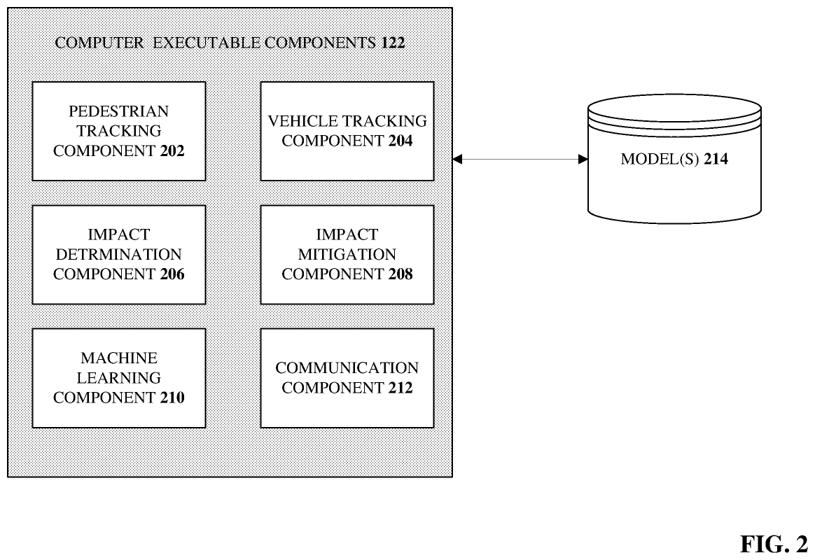

FIG. 2 illustrates a block diagram of example, non-limiting computer executable components 122 that can facilitate vehicle passenger space identification and/or contact mitigation in accordance with one or more embodiments described herein. Repetitive description of like elements employed in other embodiments described herein is omitted for sake of brevity. As shown in FIG. 2, the one or more computer executable components 122 can comprise pedestrian tracking component 202, vehicle tracking component 204, impact determination component 206, impact mitigation component 208, machine learning component 210, and/or communication component 212. In various embodiments, the computer executable components can be communicatively coupled to and/or can further comprise machine learning based model(s) 214, which can be stored in memory 118.

In various embodiments, the vehicle tracking component 204 can determine a second location of a second vehicle (e.g., a vehicle 602) and a speed differential between a first vehicle (e.g., vehicle 102) and the second vehicle (e.g., vehicle 602). It is noted that the first location of the first vehicle can comprise a current location or position of the first vehicle. Similarly, the second location of the second vehicle can comprise a current location or position of the second vehicle. Additionally, or alternatively, the pedestrian tracking component 202 can determine the third location of the pedestrian 504. It is noted that the third location of the pedestrian 504 can comprise a current location or position of the pedestrian 504. In various embodiments, the vehicle tracking component 204 and/or pedestrian tracking component 202 can utilize one or more distance sensors 302 in order to determine three-dimensional positions of vehicles (e.g., vehicles other than the vehicle 102), pedestrians, or other objects relative to the vehicle 102 herein. In this regard, the vehicle tracking component 204 and/or pedestrian tracking component 202 can utilize and/or integrate data from the distance sensors 302 to generate a three-dimensional digital representation surrounding the vehicle 102. In various implementations, the distance sensors 302 can comprise one or more of a light detection and ranging (lidar) sensor, a radar sensor, an ultrasonic sensor, an infrared sensor, a laser sensor, a light emitting diode (LED) sensor, a capacitive sensor, a time of flight sensor, a hall effect sensor, or an optical sensor. In some embodiments a plurality of optical sensors or other suitable sensors can be utilized to determine or triangulate positions of vehicles, pedestrians, or other objects relative to the vehicle 102 herein. Further, plurality of optical sensors or other suitable sensors can be utilized to determine shapes (e.g., shapes of other vehicles), which can be utilized (e.g., by the impact determination component) to determine a type, make, or model of a vehicle (e.g., vehicle 602), or other suitable features or aspects of a vehicle 602.

According to an embodiment, the impact determination component 206 can determine, based on a first location of a first vehicle (e.g., vehicle 102), a second location of a second vehicle (e.g., vehicle 602), and a speed differential between the first vehicle (e.g., vehicle 102) and the second vehicle (e.g., vehicle 602), whether a first collision between the first vehicle (e.g., vehicle 102) and the second vehicle (e.g., vehicle 602) is threshold likely to occur. Such a threshold can be defined, or can be determined, for instance, using machine learning (e.g., via the machine learning component 210) applied to past collisions between other vehicles and/or pedestrians. In one or more embodiments, the impact determination component 206 can determine a location of a first vehicle (e.g., a vehicle 102 comprising the system 100) using a global positioning system (GPS) sensor (e.g., of the vehicle electronic systems/devices 108) or another suitable sensor, device, or component of the vehicle 102. In various embodiments, the impact determination component 206 and/or vehicle tracking component 204 can determine a location (e.g., a second location) of the second vehicle (e.g., vehicle 602) using one or more distance sensors 302. Further, a plurality of readings of the distance sensors 302 over time, compared (e.g., via the impact determination component 206 and/or vehicle tracking component 204) to a speed of the first vehicle (e.g., vehicle 102), can be utilized (e.g., via the impact determination component 206) in order to determine a speed differential between the first vehicle and the second vehicle.

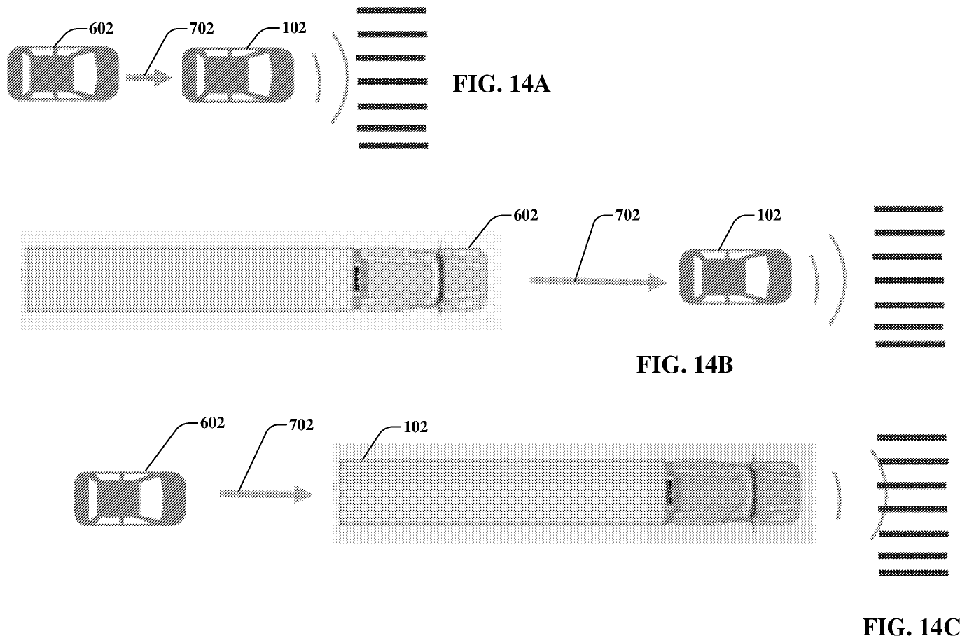

In some implementations, the impact determination component 206 can further determine that the first collision between the first vehicle (e.g., vehicle 102) and the second vehicle (e.g., vehicle 602) is threshold likely to occur based on can be based on one or more of a variety of factors, such as a type of the second vehicle (e.g., as determined using a defined machine vision algorithm), distance between vehicles, vehicle speed, vehicle trajectories, pedestrian position, pedestrian trajectory, quantity of pedestrians, time of day, road conditions, tire size, maintenance history, or other suitable factors. In various embodiments, one or more of the above-noted factors can be determined (e.g., via the impact determination component 206 and/or vehicle tracking component 204), for instance, using a defined computer or machine vision algorithm. For example, if the impact determination component 206 or vehicle tracking component 204 determines that the vehicle 602 comprises a semi-truck, the safe distance needed to safely stop without contacting the vehicle 102 may be greater than if the vehicle 602 comprised a passenger car. In this regard, with respect to FIGS. 14A-14C, the distance 702 (e.g., a safe distance between a vehicle 102 and vehicle 602 in order to avoid a rear-end collision) can vary depending on the type of vehicle 602 and/or vehicle 102. Such a safe distance can be predefined (e.g., in a lookup table) or determined using a defined safe distance algorithm (e.g., using machine learning (e.g., via the machine learning component 210) applied to past collisions between other vehicles and/or pedestrians).

According to an embodiment, the impact determination component 206 can further determine (e.g., based on a third location of a pedestrian and the first collision being determined to be threshold likely to occur) whether a second collision (e.g., between the vehicle 102 and the pedestrian 504) is threshold likely to occur (e.g., as a result of being pushed by the vehicle 602 due to a rear-end collision between the vehicle 102 and the vehicle 602). In various embodiments, such a second collision can be determined to be threshold likely to occur based on a defined safe distance threshold (e.g., based on one or more of a variety of factors, such as a type of the second vehicle, as determined using a defined machine vision algorithm, distance between vehicles, vehicle speed, vehicle trajectories, pedestrian position, pedestrian trajectory, quantity of pedestrians, time of day, road conditions, tire size, maintenance history, or other suitable factors) being exceeded (e.g., distance between vehicles is less than or equal to the safe distance threshold). Such a threshold can be defined, or can be determined, for instance, using machine learning (e.g., via the machine learning component 210) applied to past collisions between other vehicles and/or pedestrians.

In some embodiments, the impact determination component 206 can further determine whether the first collision between the first vehicle and the second vehicle is threshold likely to occur based on a road condition applicable to the first vehicle or the second vehicle. In this regard, a safe distance between a vehicle 102 and vehicle 602 to avoid a rear-end collision can vary depending on the road condition (e.g., of a street 506). For example, such a safe distance can be determined (e.g., via the impact determination component 206) to be larger if the road condition comprises snow cover or wet from rain as compared to a safe distance on a dry, warm, sunny day.

In another embodiment, the impact determination component 206 can further determine whether the first collision between the first vehicle and the second vehicle is threshold likely to occur based on historical accident data associated with a location applicable to the vehicle 102. In this regard, the impact determination component 206 can modify a safe braking distance (e.g., for the vehicle 602) based on degree of risk at a certain location. For instance, the impact determination component 206 can apply a weight to modify the safe distance based on the frequency of collisions at a given location.

According to an embodiment, the impact mitigation component 208 can (e.g., based on the second collision being determined to be threshold likely to occur) facilitate an impact mitigation action determined to mitigate a collision between the vehicle 102 and the pedestrian 504 (e.g., a second collision). It is noted that the impact mitigation action can comprise one or more of a variety of impact mitigation actions. Determination of a suitable impact mitigation action (e.g., via the impact mitigation component 208) can be based on one or more of a variety of factors, such as distance between vehicles, vehicle speed, vehicle trajectories, pedestrian position, pedestrian trajectory, quantity of pedestrians, time of day, road conditions, type of vehicle, or other suitable factors. In some embodiments, a suitable impact mitigation action can be determined (e.g., by the impact mitigation component 208) using a defined lookup table, or can be determined, for instance, using machine learning (e.g., via the machine learning component 210) applied to past collisions between other vehicles and/or pedestrians.

In some implementations, such an impact mitigation action can comprise an alert transmitted (e.g., via the communication component 212) external to the vehicle 102 (e.g., a first vehicle). Such an alert can comprise an audible warning (e.g., broadcasted via speaker 308 external to the vehicle 102) or a visual warning (e.g., via flashing lights 304 of the vehicle 102). In additional implementations, the impact mitigation action can comprise an alert transmitted to a wearable device (e.g., wearable device 404) applicable to the pedestrian 504. In one or more embodiments, the communication component 212 can (e.g., based on the second collision between the first vehicle and the pedestrian 504 being determined to be threshold likely to occur) transmit alert data representative of an alert to a mobile device 402 associated with the pedestrian 504. In this regard, the impact mitigation action can comprise transmission (e.g., via the communication component 212) of the alert. It is noted that, in various implementations, the mobile device 402 can be configured to display a visual representation of the alert, for instance, if a screen of the mobile device 402 is unlocked when the alert data is received by the mobile device 402. However, the mobile device 402 can be configured not to display a visual representation of the alert, for instance, if a screen of the mobile device 402 is locked when the alert data is received by the mobile device 402. In this regard, the mobile device 402 can, in some implementations, generate an audible alert based on the alert data regardless of whether the screen of the mobile device 402 is unlocked, though in other implementations, the mobile device 402 can be configured not to generate the audible alert, for instance, if a screen of the mobile device 402 is locked when the alert data is received by the mobile device 402.

In one or more embodiments, the communication component 212 can (e.g., based on the second collision between the first vehicle and the pedestrian being determined to be threshold likely to occur) transmit alert data representative of an alert to a traffic signal 406 applicable to the pedestrian 504. In this regard, the traffic signal 406 can be configured to display a corresponding signal, such as a do-not-cross signal, danger signal, visual signal, color-coded signal, or another suitable signal intended to alert the pedestrian 504 to a potential collision (e.g., a second collision herein).

In various embodiments, the impact determination component 206 can compare estimated/calculated risks (e.g., using a defined risk estimation algorithm) associated with various locations that the vehicle 102 could move to, prior to being struck by a vehicle 602 (e.g., under the assumption that the collision is imminent and/or unavoidable). The impact determination component 206 can thus determine potential movement to be facilitated by the vehicle 102 prior to being struck by the vehicle 602, and/or determine a location least likely to cause a contact or injury to the pedestrian 504. For instance, the impact mitigation action determined (e.g., via the impact mitigation component 208) to mitigate the second collision can comprise moving the first vehicle from the first location to a fourth location (e.g., to a location other than a current location of the vehicle 102) in response to a determination (e.g., by the impact mitigation component 208) that the fourth location poses a lesser risk of the second collision (e.g., a collision between the vehicle 102 and the pedestrian 504) occurring than that of the first location. For example, the vehicle 102 can be configured to autonomously move (e.g., as facilitated by the impact mitigation component 208) from a first location (e.g., a location waiting at a red light) to the fourth location (e.g., moving to an opposite side of the crosswalk 512). In additional implementations, the impact mitigation action determined (e.g., via the impact mitigation component 208) to mitigate the second collision can comprise holding the first vehicle at the first location in response to a determination (e.g., via the impact determination component 206) that a fourth location, other than the first location, poses a heightened risk of the second collision occurring than that of the first location. In further implementations, the impact mitigation action determined to mitigate the second collision can comprise a lane change applicable to the first vehicle (e.g., autonomously moving the vehicle 102 from lane 508 to lane 510).

According to an embodiment, the pedestrian tracking component 202 can determine, based on a facial recognition of the pedestrian 504, whether the pedestrian 504 is threshold likely to be aware of the second collision. Such a threshold can be defined, or can be determined, for instance, using machine learning (e.g., via the machine learning component 210) applied to past collisions between other vehicles and/or pedestrians. In this regard, the impact mitigation action determined (e.g., via the impact mitigation component 208) to mitigate the second collision can be further determined based on the facial recognition of the pedestrian 504. For example, the pedestrian tracking component 202 can determine a direction of focus (e.g., of the eyes) of the pedestrian 504 in order to determine whether the pedestrian 504 is likely to be paying attention, and thus potentially aware of a potential collision near the pedestrian 504.

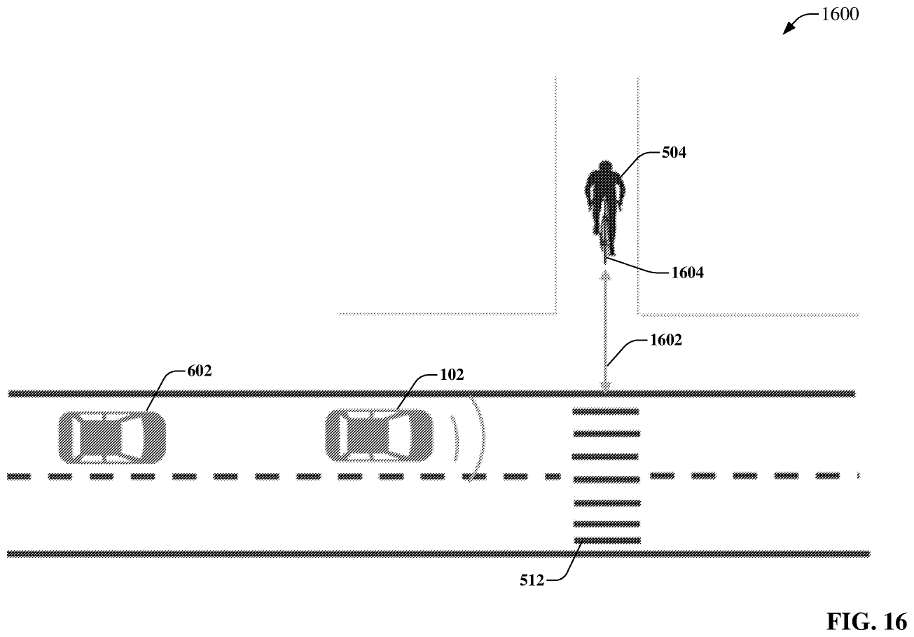

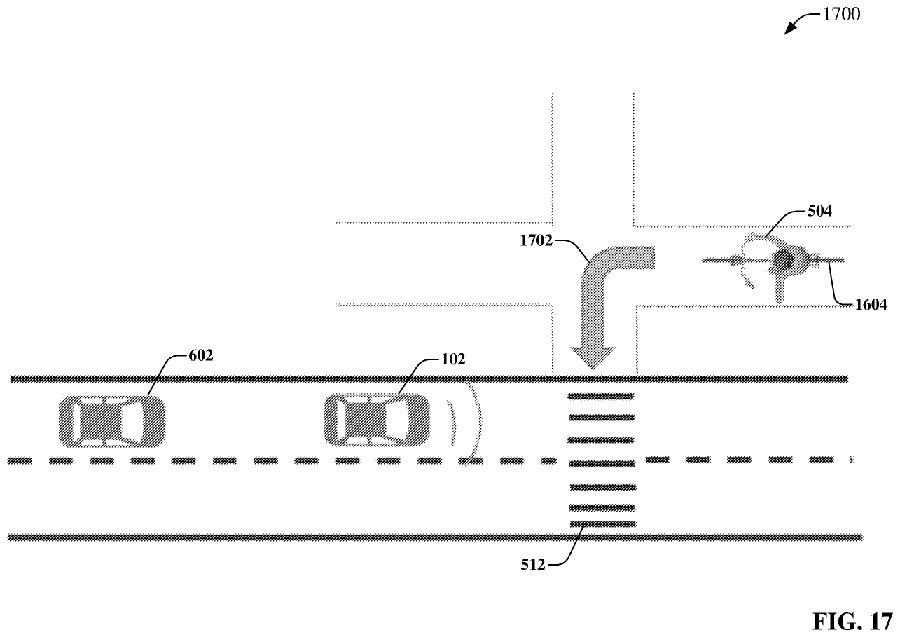

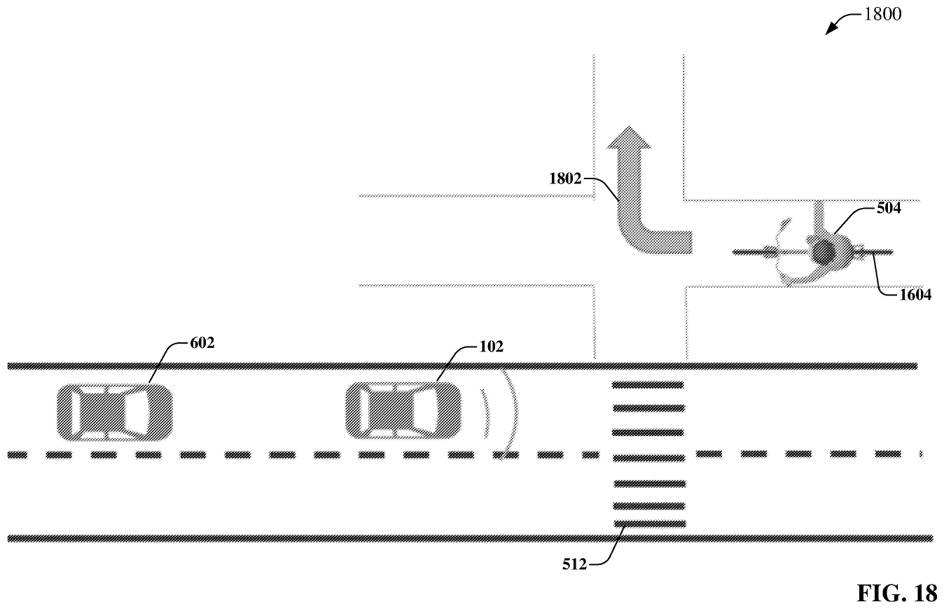

In some embodiments, the pedestrian 504 can be operating a wheeled pedestrian vehicle 1604 (see FIGS. 16-18 in which the pedestrian 504 operates a bicycle, motor scooter, or another suitable wheeled vehicle, such as a two-wheeled vehicle). In this regard, the impact determination component 206 can further determine whether the second collision between the first vehicle and the pedestrian 504 is threshold likely to occur based on a trajectory of the wheeled pedestrian vehicle 1604. Such a threshold can be defined, or can be determined, for instance, using machine learning (e.g., via the machine learning component 210) applied to past collisions between other vehicles and/or pedestrians. Further, it is noted that the pedestrian tracking component 202 can (e.g., based on a signal applicable to the wheeled vehicle) determine a predicted trajectory applicable to the wheeled pedestrian vehicle 1604.

In an embodiment, the machine learning component 210 can (e.g., using machine learning applied to past first collusions other than the first collision or to past second collisions other than the second collision) generate a collision probability model (e.g., of the models 214). In this regard, the impact determination component 206 can further determine whether the first collision between the first vehicle (e.g., vehicle 102) and the second vehicle (e.g., vehicle 602) is threshold likely to occur, whether the second collision between the first vehicle and the pedestrian 504 is threshold likely to occur, and/or whether a collision between the vehicle 102 and a wheeled pedestrian vehicle 1604 is threshold likely to occur, using the collision probability model.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence (A.I.) model and/or machine learning (M.L.) or an M.L. model that can learn to perform the above or below described functions (e.g., via training using historical training data and/or feedback data).

In some embodiments, machine learning component 210 can comprise an A.I. and/or M.L. model that can be trained (e.g., via supervised and/or unsupervised techniques) to perform the above or below-described functions using historical training data comprising various context conditions that correspond to various augmented network optimization operations. In this example, such an A.I. and/or M.L. model can further learn (e.g., via supervised and/or unsupervised techniques) to perform the above or below-described functions using training data comprising feedback data, where such feedback data can be collected and/or stored (e.g., in memory) by the machine learning component 210. In this example, such feedback data can comprise the various instructions described above/below that can be input, for instance, to a system herein, over time in response to observed/stored context-based information.

A.I./M.L. components herein can initiate an operation(s) associated with a based on a defined level of confidence determined using information (e.g., feedback data). For example, based on learning to perform such functions described above using feedback data, performance information, and/or past performance information herein, a machine learning component 210 herein can initiate an operation associated with determining various thresholds herein (e.g., a motion pattern thresholds, input pattern thresholds, similarity thresholds, authentication signal thresholds, audio frequency thresholds, or other suitable thresholds).

In an embodiment, the machine learning component 210 can perform a utility-based analysis that factors cost of initiating the above-described operations versus benefit. In this embodiment, the machine learning component 210 can use one or more additional context conditions to determine various thresholds herein.

To facilitate the above-described functions, a machine learning component 210 herein can perform classifications, correlations, inferences, and/or expressions associated with principles of artificial intelligence. For instance, the machine learning component 210 can employ an automatic classification system and/or an automatic classification. In one example, the machine learning component 210 can employ a probabilistic and/or statistical-based analysis (e.g., factoring into the analysis utilities and costs) to learn and/or generate inferences. The machine learning component 210 can employ any suitable machine-learning based techniques, statistical-based techniques and/or probabilistic-based techniques. For example, the machine learning component 210 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the machine learning component 210 can perform a set of machine-learning computations. For instance, the machine learning component 210 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

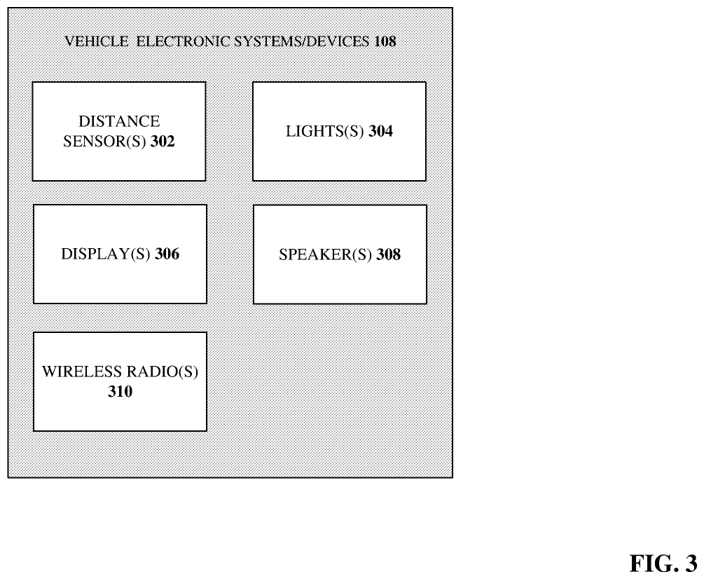

FIG. 3 illustrates a block diagram of example, non-limiting vehicle electronic systems/devices 108 in accordance with one or more embodiments described herein. Repetitive description of like elements employed in other embodiments described herein is omitted for sake of brevity. In various embodiments, the vehicle electronic systems/devices 108 can comprise one or more of distance sensors 302 (e.g., sensors external or internal to the vehicle 102 that are arranged to detect distance between the vehicle 102 and other objects (e.g., other vehicles, pedestrians, etc.) and/or to determine potential collisions, such as one or more of a light detection and ranging (lidar) sensor, a radar sensor, an ultrasonic sensor, an infrared sensor, a laser sensor, a light emitting diode (LED) sensor, a capacitive sensor, a time of flight sensor, a hall effect sensor, or an optical sensor, or another suitable sensors), light(s) 304, display(s) 306 (e.g., infotainment devices, touchscreen displays, etc.), speaker(s) 308, and/or wireless radio(s) 310.

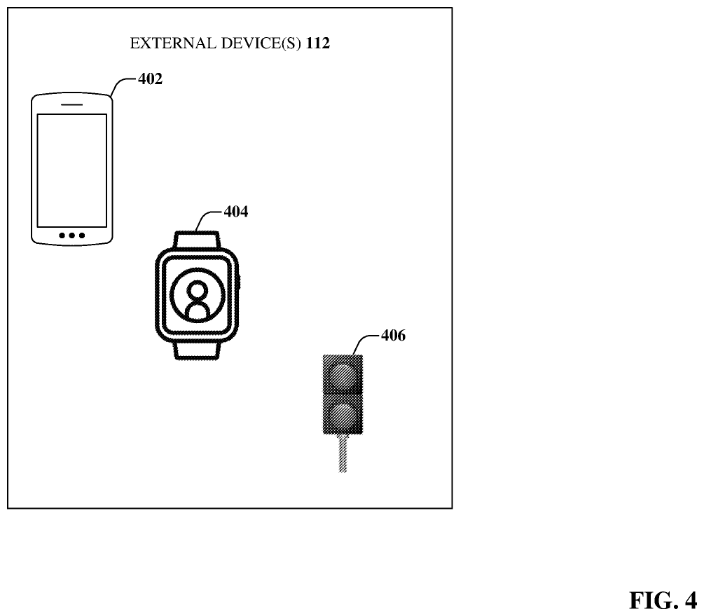

FIG. 4 illustrates a block diagram of example, non-limiting external devices 112 in accordance with one or more embodiments described herein. In this regard, the external devices 112 can comprise mobile device 402 (e.g., a smartphone), wearable device 404 (e.g., a smartwatch, headphones, augmented reality headset or glasses, virtual reality headset or glasses, mixed reality headset or glasses, smart ring, smart glasses, smart jewelry, smart clothing, fitness tracking device, or another suitable wearable device), a traffic signal 406 (e.g., a traffic light, cross walk signal, or another suitable traffic signal), or other suitable external devices.

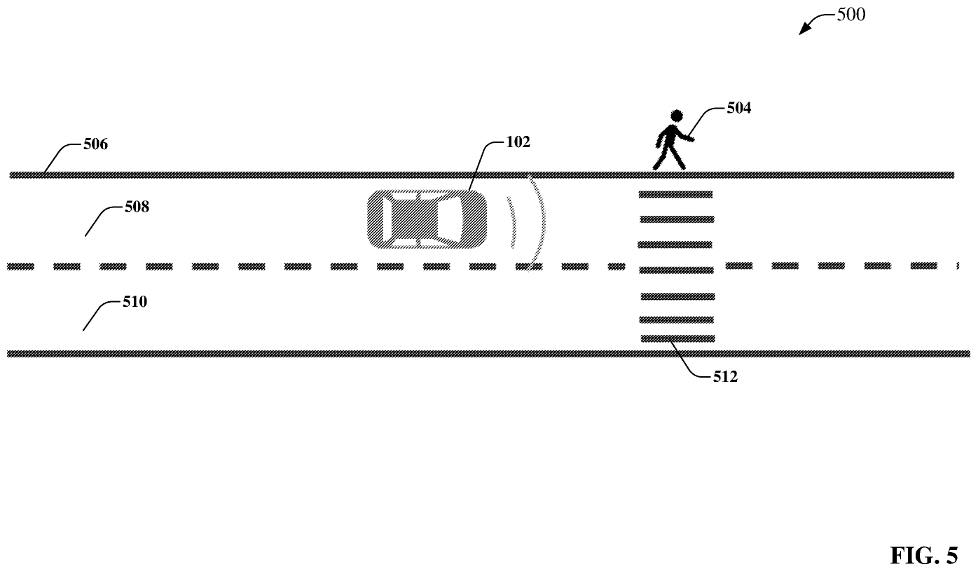

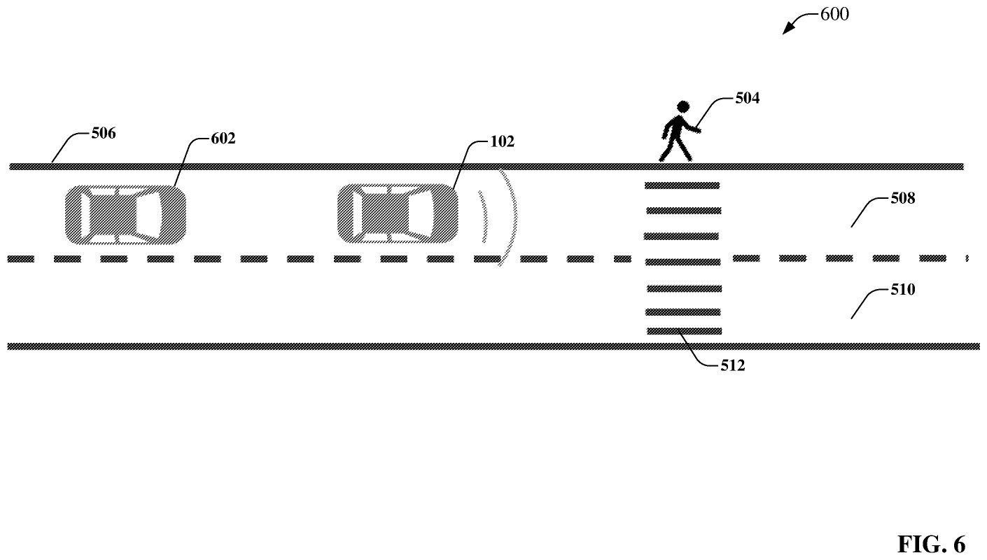

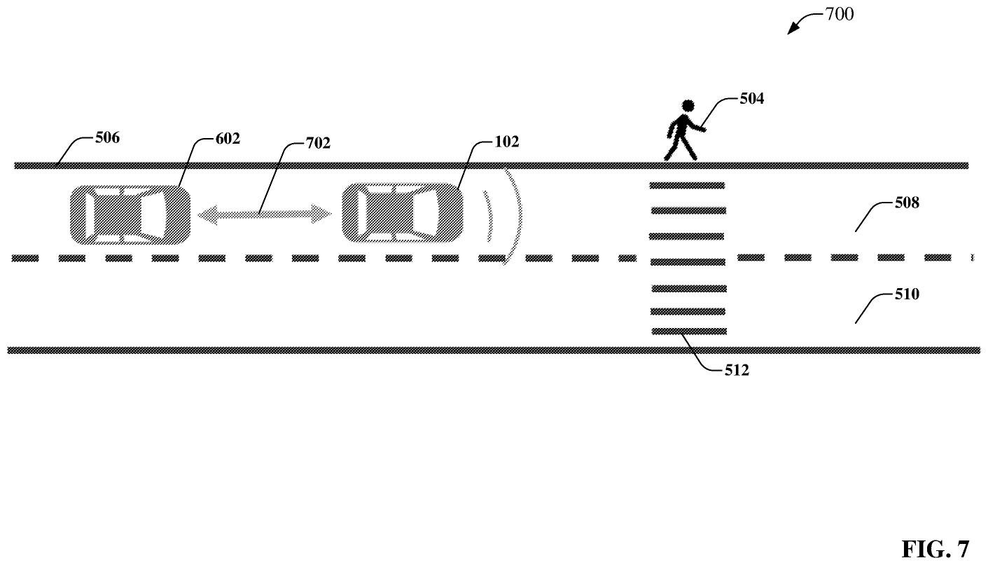

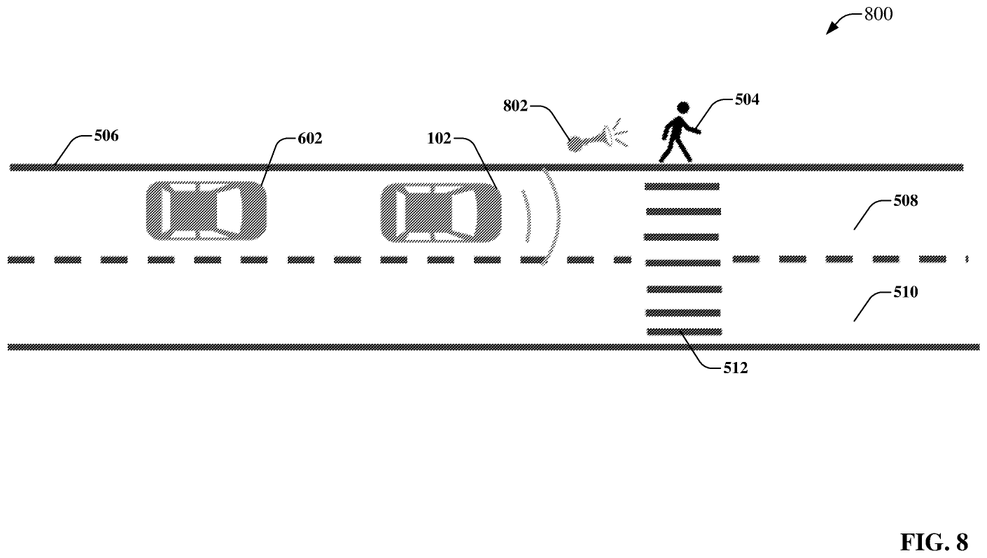

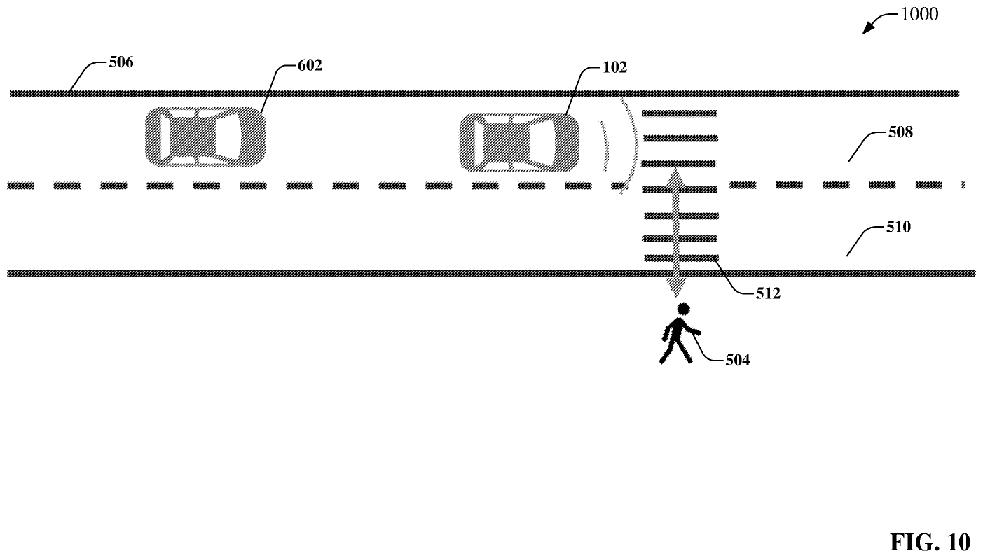

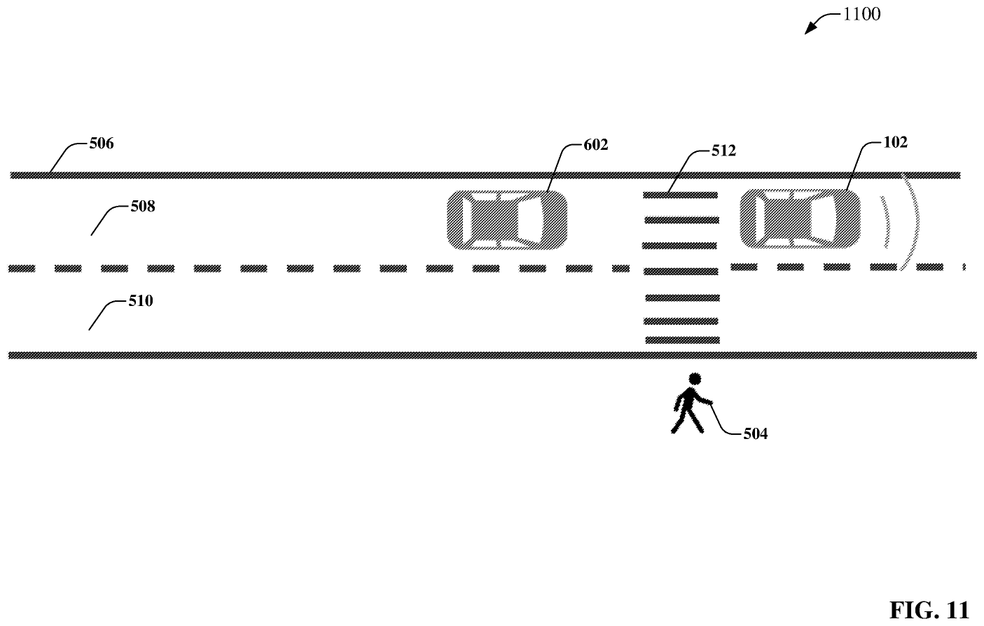

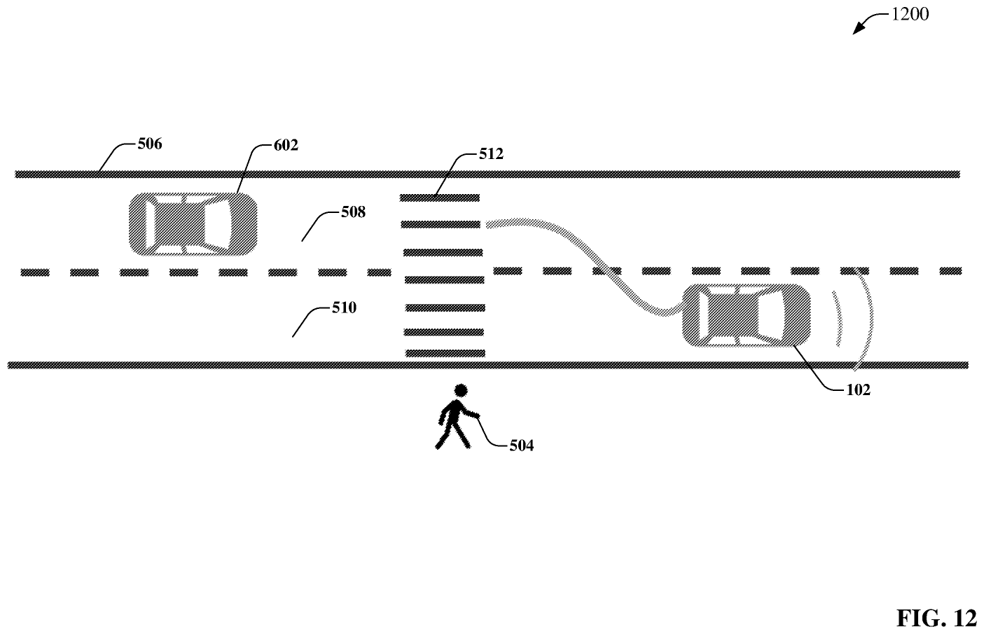

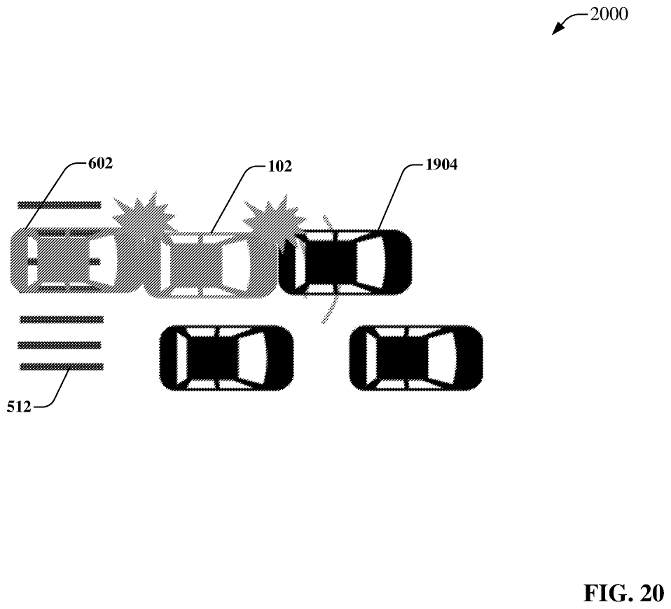

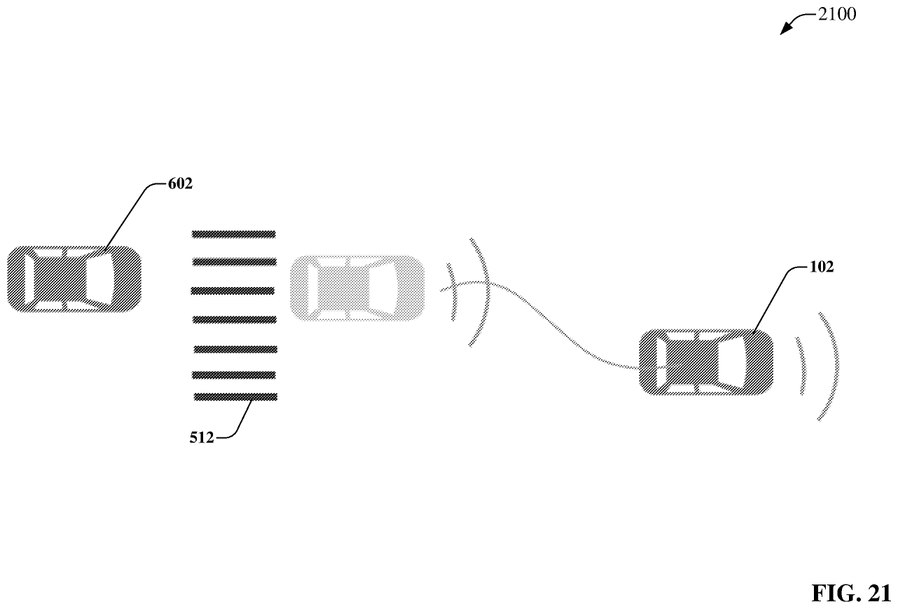

FIGS. 5-22 illustrate an example, non-limiting scenarios in accordance with various embodiments described herein. In some embodiments, such scenarios can comprise a series of events or steps, however, the scenarios are presented in a non-limiting sequence and/or one or more steps or scenarios can be added, duplicated, omitted, etc.

Scenario 500 can comprise vehicle 102, pedestrian 504, street 506, lane 508, lane 510, and/or crosswalk 512. In scenario 500, the vehicle 102 (e.g., an autonomous vehicle) starts braking when approaching the crosswalk 512 (e.g., to let pedestrian 504 pass). In scenario 600, when the vehicle 102 has started to brake (e.g., to avoid the pedestrian 504), the vehicle tracking component 204 can start detecting if there is a second vehicle (e.g., vehicle 102) approaching in the same lane as the vehicle 102 (e.g., lane 508). In scenario 700, the vehicle tracking component 204 can determine the distance 702, which can enable the impact determination component 206 to determine whether the distance 702 comprises a safe distance (e.g., satisfies a safe distance threshold). In various embodiments, the vehicle tracking component 204 can determine a type or model of the vehicle 602 (e.g., using a defined computer vision algorithm). The impact determination component 206 can then determine the safe distance threshold for that particular vehicle 602, or type or class of vehicle (e.g., using a defined lookup table, algorithm, or based on machine learning herein) based on speeds of the respective vehicles, road conditions, or other suitable factors. The impact determination component 206 can then compare the distance 702 to the safe distance (e.g., a safe braking distance). If the vehicle 602 is determined (e.g., via the vehicle tracking component 204 and/or impact determination component 206) to have eclipsed the safe braking distance and/or the vehicle 602 is determined not to be decelerating rapidly enough to avoid a collision between the vehicle 602 and the vehicle 102, the impact determination component 206 can determine a probability of an imminent collision (e.g., a first collision herein). In scenario 800, the impact mitigation component 208 can facilitate generation of an audible warning (e.g., horn honk 802—from the vehicle 102) or a visual warning to warn the pedestrian 504, in which the audible or visual warning is intended to prevent the pedestrian 504 from crossing the street 506, or if the pedestrian 504 is already crossing the street 506, alert the pedestrian 504 to return to a sidewalk (not depicted) adjacent to the street 506 or to different safer area (e.g., relative to safety of the street 506).

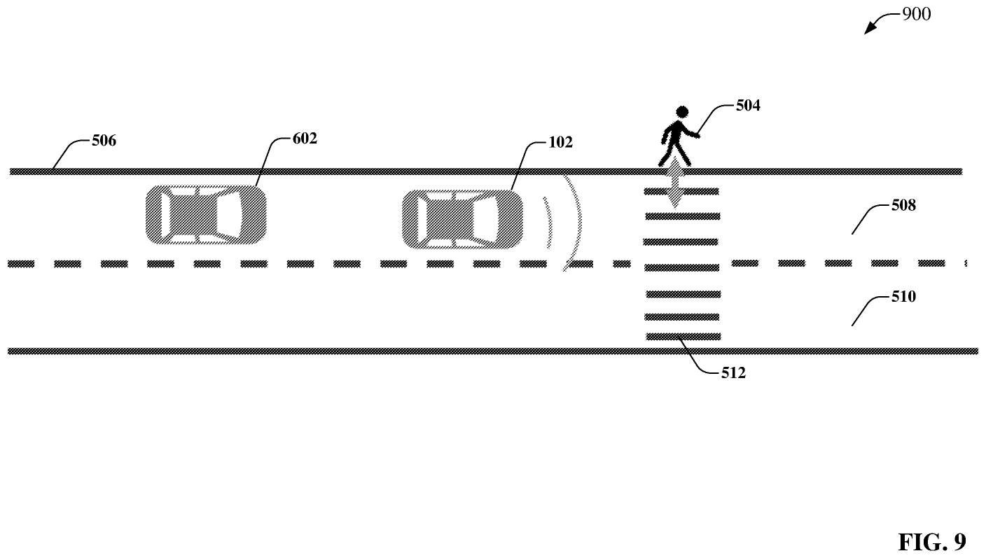

FIGS. 9-12 illustrate example, non-limiting scenarios 900-1200 in accordance with one or more embodiments described herein. In various embodiments, as depicted in scenarios 900 and 1000 the pedestrian tracking component 202 can determine where the pedestrian 504 is standing relative to the vehicle 102 and/or street 506. In various embodiments, and as depicted in scenario 1100, the pedestrian tracking component 202 can facilitate facial detection of the pedestrian 504. Such facial detection can be utilized in order to determine whether the pedestrian 504 is likely to be paying attention to the vehicle 102 and/or vehicle 602, and thus a potential collision. For example, if the pedestrian 504 is determined (e.g., via the pedestrian tracking component 202) to be looking at the vehicle 102, and the pedestrian remains off the street, the impact mitigation component 208 can cause the vehicle 102 to continue driving (e.g., instead of stopping to avoid the pedestrian 504) and/or perform a lane change to avoid the first collision (e.g., being rear-ended by the vehicle 602). Further, the pedestrian tracking component 202 can determine whether the pedestrian 504 does not cross the street 506 (e.g., or returns to a sidewalk or other safe area) or whether the pedestrian 504 is crossing a lane common to the vehicle 102 (e.g., lane 508) or a different lane (e.g., lane 510). Based on the position and/or predicted trajectory of the pedestrian 504, the impact mitigation component 208 can determine a corresponding impact mitigation action. For example, if the impact determination component 206 determines that the vehicle 102 and/or vehicle 602 will exit (e.g., pass over/pass by) the crosswalk 512 before the pedestrian 504 could become in the path of the vehicle 102 and/or vehicle 602, the impact mitigation component 208 can cause the vehicle 102 can continue driving in the lane 508 and pass the crosswalk 512 in order to move the imminent collision (e.g., the first collision) from an area of risk to the pedestrian 504 to an area of lower risk to the pedestrian 504 (e.g., after the crosswalk 512) or avoid the collision between the vehicle 102 or vehicle 602 entirely. For instance, in scenario 1200, after the vehicle 102 has passed the crosswalk 512, the impact mitigation component 208 can cause the vehicle 102 increase its speed and/or perform a lane change to minimize the risk of being impacted by the vehicle 602.

In an example (e.g., corresponding to scenario 900), if the pedestrian tracking component 202 determines that pedestrian 504 is close to the lane 508 (e.g., within a defined distance), the impact determination component 206 can determine that is likely that the pedestrian 504 has already started crossing, or is distracted (e.g., listening to music). Thus, the risk of a collision with the pedestrian 504 (e.g., a second collision herein) can be elevated, for instance, because of the closer proximity of the pedestrian 504 to the vehicle 102. In another example (e.g., corresponding to scenario 1000), risk of a collision with the pedestrian 504 (e.g., a second collision herein) can be lower than that of scenario 900, for instance, because the pedestrian 504 has more distance to traverse before intersecting the path of the vehicle 102 (e.g., entering the lane 508). In another example (e.g., corresponding to scenario 1100), if the pedestrian 504 has not commenced crossing the street 506, the impact mitigation component 208 can prevent the vehicle 102 from braking and further cause the vehicle 102 continue driving to potentially prevent the first collision (e.g., between the vehicle 102 and the vehicle 602).

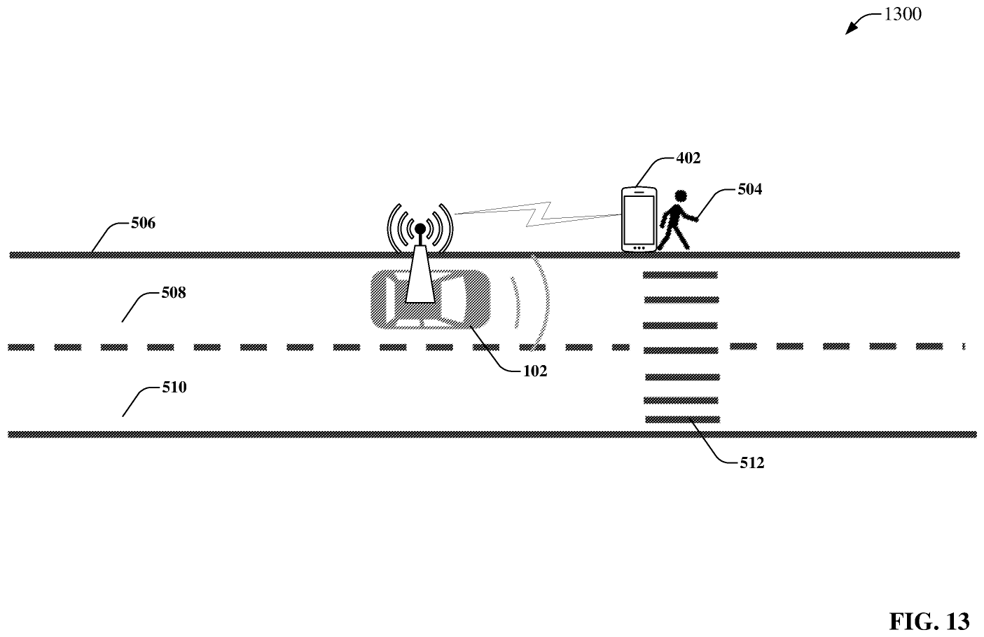

FIG. 13 illustrates an example, non-limiting scenario 1300 in accordance with one or more embodiments described herein. In scenario 1300, if the pedestrian 504 is determined to be already crossing the street 506 (e.g., as detected via a mobile device 402 associated with the pedestrian 504 via a GPS of the mobile device 402), and a screen of the mobile device 402 is unlocked or on, (e.g., receiving inputs from the pedestrian 504), the communication component 212 can send a notification to the mobile device 402 to be displayed via the screen of the mobile device 402. The notification can be transmitted by the communication component 212, for instance, using a short range communication, such as Bluetooth, ultrawideband or millimeter wave signal, Wi-Fi, or another suitable short range signal. In other embodiments, the notification can be transmitted (e.g., via the communication component 212) via a cloud server or network communicatively coupled to the vehicle 102 and mobile device 402 (or wearable device 404 or another suitable device associated with the pedestrian 504). In various embodiments, the notification can be configured to be received by any suitable mobile device within a defined range of the vehicle 102. In an example, if the pedestrian 504 is determined (e.g., via the pedestrian tracking component 202 and/or mobile device 402) to be crossing the street 506, and the mobile device 402 is receiving inputs from the pedestrian 504 (e.g., screen is on or unlocked), the notification or alert can be presented via the screen of the mobile device 402 and/or via a speaker of the mobile device 402. In another example, if the pedestrian 504 is determined (e.g., via the pedestrian tracking component 202 and/or mobile device 402) to be crossing the street 506, but the mobile device is locked (e.g., not presently in use by the pedestrian 504), then the visual notification and/or audible notification can be configured not to be rendered via the mobile device 402 (e.g., to avoid creating a new distraction for the pedestrian 504). It is noted that alerts rendered via the mobile device 402 can additionally, or alternatively, be context dependent. For instance, whether the alert is rendered via a screen of the mobile device 402, a speaker of the mobile device 402, or otherwise rendered can depend on a time of day, location, or another suitable context. For example, the mobile device 402 can be configured to flash a light during nighttime or generate a sound during daytime.

FIGS. 14A-14C illustrate example, non-limiting scenarios in accordance with one or more embodiments described herein. In this regard, it is noted that the impact determination component 206 can determine that a first collision between the first vehicle (e.g., vehicle 102) and the second vehicle (e.g., vehicle 602) is threshold likely to occur based on a type of the second vehicle (e.g., as determined using a defined machine vision algorithm). Such a threshold can be defined, or can be determined, for instance, using machine learning (e.g., via the machine learning component 210) applied to past collisions between other vehicles and/or pedestrians. For example, if the impact determination component 206 determines that the vehicle 602 comprises a semi-truck, the safe distance needed to safely stop without contacting the vehicle 102 may be greater than if the vehicle 602 comprises a passenger car. In FIG. 14C, because the weight of the vehicle 102 (in this example, the vehicle 102 can comprise a semi-truck and the vehicle 602 can comprise a passenger car) can be determined to be significantly greater than that of the vehicle 602, the impact determination component 206 can determine that a first collision resulting from the vehicle 602 rear-ending the vehicle 102 would not pose a risk of the vehicle 102 being pushed into a projected or observed path of the pedestrian 504 (e.g., into a crosswalk 512).

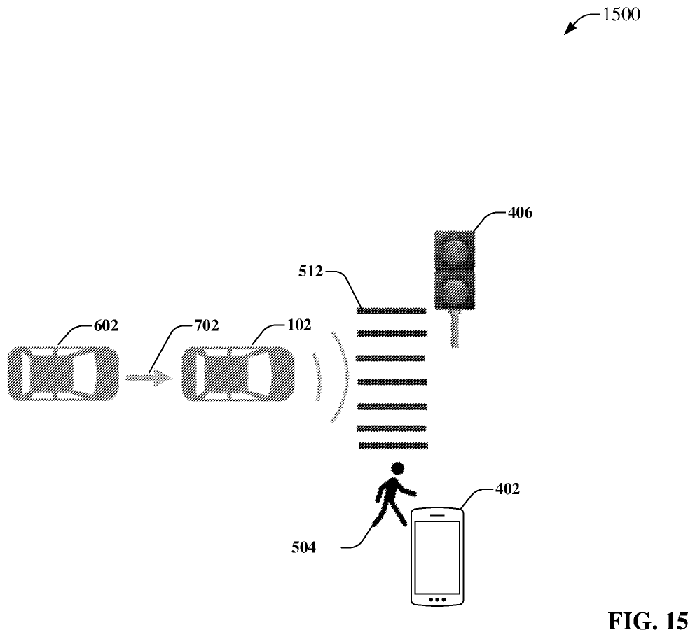

FIG. 15 illustrates an example, non-limiting scenario 1500 in accordance with one or more embodiments described herein. Scenario 1500 depicts exemplary vehicle-to-infrastructure communication in accordance with various embodiments described herein. In one or more embodiments, the communication component 212 can (e.g., based on the second collision between the first vehicle and the pedestrian being determined to be threshold likely to occur) transmit alert data representative of an alert to a traffic signal 406 applicable to the pedestrian 504. In this regard, the traffic signal 406 can be configured to display a corresponding signal, such as a do-not-cross signal, danger signal, visual signal, or another suitable signal intended to alert the pedestrian 504 of a potential collision (e.g., a second collision herein). Thus, in an example, if an imminent collision (e.g., a first collision herein) is determined via the impact determination component 206, the communication component 212 can communicate (e.g., via a wireless communication) with the traffic signal 406 to cause the traffic signal 406 to change to red to notify the pedestrian 504, or other pedestrians, not to cross the street 506. In another embodiment, the traffic signal 406 can relay a communication between a vehicle 102 (e.g., and corresponding communication component 212) and a mobile device 402 (e.g., to increase a range of short-range communication from the vehicle 102).

FIGS. 16-18 illustrates example, non-limiting scenarios 1600-1800 in accordance with one or more embodiments described herein. In scenario 1600, the vehicle tracking component 204 and/or pedestrian tracking component 202 can detect an approaching wheeled pedestrian vehicle 1604. The vehicle tracking component 204 and/or pedestrian tracking component 202 can then determine the speed of the pedestrian 504 and/or wheeled pedestrian vehicle 1604. The vehicle tracking component 204 and/or pedestrian tracking component 202 can additionally, or alternatively, determine the distance 1602 between the wheeled pedestrian vehicle 1604 and the crosswalk 512 in order to determine (e.g., via the impact determination component 206) whether the vehicle 102 has time to safely pass the crosswalk 512 before the wheeled pedestrian vehicle 1604 reaches the crosswalk 512 (e.g., to potentially void the first collision between the vehicle 102 and the vehicle 602). As depicted in scenarios 1700 and 1800, the vehicle tracking component 204 and/or pedestrian tracking component 202 can be configured to determine hand or arm movements or other signals of the pedestrian 504 or the wheeled pedestrian vehicle 1604 to determine an intention of the cyclist (e.g., a future direction of travel). For example, a left arm signal in scenario 1700 can be determined by the vehicle tracking component 204 and/or pedestrian tracking component 202 to indicate that the pedestrian 504 intends to turn toward the crosswalk 512 (e.g., direction 1702) and potentially cross the crosswalk 512. Conversely, a right arm signal in scenario 1800 can be determined by the vehicle tracking component 204 and/or pedestrian tracking component 202 to indicate that the pedestrian 504 intends to turn away from the crosswalk 512 (e.g., direction 1802) and potentially not cross the crosswalk 512. In another embodiment, the vehicle 102 can be communicatively coupled (e.g., via the communication component 212) to the wheeled pedestrian vehicle 1604 or to a mobile device 402 associated with the wheeled pedestrian vehicle 1604, for instance, in order to determine route information applicable to the wheeled pedestrian vehicle 1604. In this regard, the impact determination component 206 can determine a potential collision associated with determined trajectories of a wheeled pedestrian vehicle 1604 and/or a pedestrian 504, based on communication of navigation information, applicable to the wheeled pedestrian vehicle 1604 or pedestrian 504, to/from the vehicle 102 (e.g., via the communication component 212).

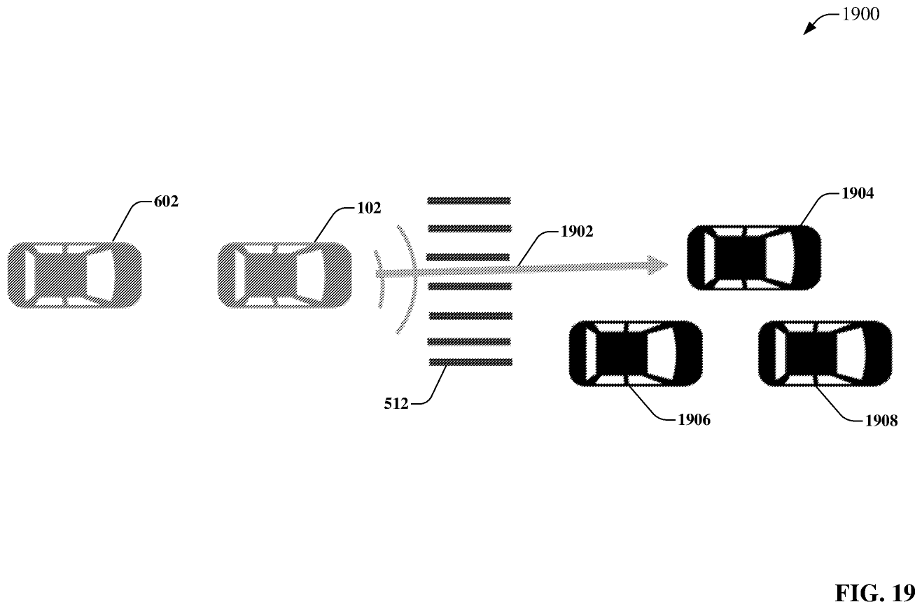

FIGS. 19-21 illustrates example, non-limiting scenarios 1900-2100 in accordance with one or more embodiments described herein. In scenario 1900, the vehicle tracking component 204 can determine a distance 1902 between the vehicle 102 and a vehicle ahead of the vehicle 102 (e.g., vehicle 1904, vehicle 1906, vehicle 1908, or another suitable vehicle). Based on the distance 1902, the impact mitigation component 208 can facilitate an impact mitigation action intended to avoid a scenario 2000, in which vehicle 1904 becomes involved in a collision with the vehicle 102 and/or the vehicle 602. For instance, if the impact determination component 206 determines that a collision between the vehicle 102 and vehicle 602 is threshold likely to be imminent, regardless of possible movement by the vehicle 102 to attempt to avoid being struck by the vehicle 602, the impact mitigation component 208 can be configured not to move the vehicle 102 ahead, and thus attempt not to collide with vehicle 1904 (even though the collision with vehicle 602 has been determined to be potentially unavoidable). The foregoing can be facilitated by the impact mitigation component 208, for instance, if such an action does not pose an elevated risk to a pedestrian 504. In scenario 2100, vehicle 102 has a clear path ahead, and thus the impact mitigation component 208 can be configured to execute a maneuver, for the vehicle 102, determined (e.g., via the impact determination component 206 and/or impact mitigation component 208) to reduce a likelihood of being rear-ended by the vehicle 602, provided that such an action does not pose an elevated risk to a pedestrian 504.

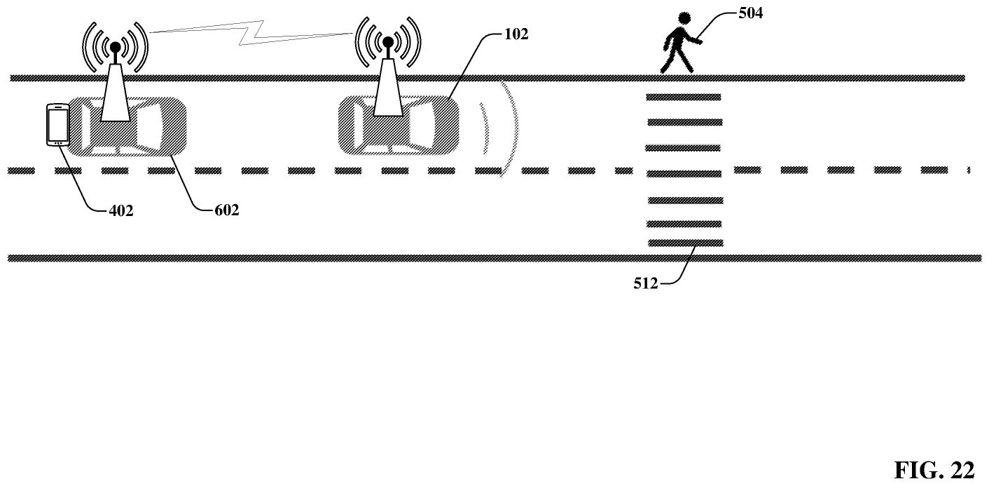

FIG. 22 illustrates an example, non-limiting scenario 2200 in accordance with one or more embodiments described herein. In scenario 2200, exemplary vehicle to vehicle (V2V) or exemplary commination between a vehicle 102 and mobile device 402 is depicted. For example, if the vehicle 602 is not V2V or vehicle to everything (V2E) enabled, the vehicle 102 can instead communicate (e.g., via the communication component 212) with a mobile device 402 associated with the vehicle 602. Such a communication can be configured to enable an alert to be presented via the mobile device 402 or vehicle 602 to warn a driver of the vehicle 602 that there exists a risk of a collision with the vehicle 102 and that the vehicle 602 should take an action to reduce that risk (e.g., increase following distance, slow down, etc.) If the vehicle 602 comprises V2V or V2E, the alert can be transmitted (e.g., via the communication component 212) directly from the vehicle 102 to the vehicle 602 (or via a server communicatively coupled to the vehicle 102 and vehicle 602 via a cellular network).

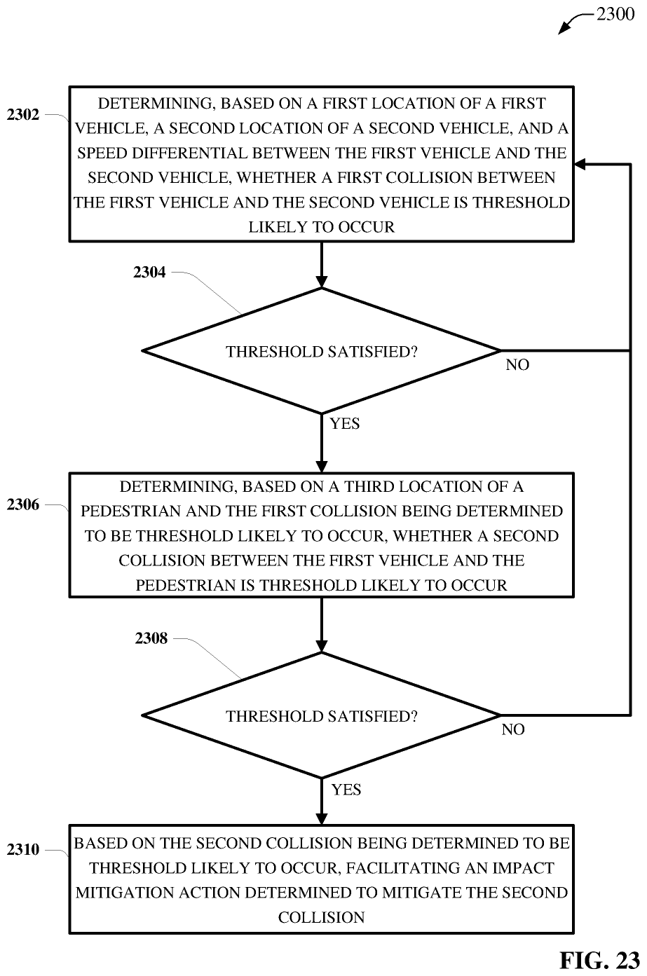

FIG. 23 illustrates a block flow diagram for a process 2300 associated with vehicle safety systems in accordance with one or more embodiments described herein. At 2302, the process 2300 can comprise determining (e.g., via an impact determination component 206), based on a first location of a first vehicle (e.g., vehicle 102), a second location of a second vehicle (e.g., vehicle 602), and a speed differential between the first vehicle and the second vehicle, whether a first collision between the first vehicle and the second vehicle is threshold likely to occur. At 2304. if the threshold (e.g., regarding a likelihood of a first collision between the first vehicle and the second vehicle) is satisfied, the process can proceed to 2306. Otherwise, the process can return to 2302. At 2306, the process 2300 can comprise determining (e.g., via an impact determination component 206), based on a third location of a pedestrian 504 and the first collision being determined to be threshold likely to occur, whether a second collision between the first vehicle and the pedestrian 504 is threshold likely to occur. At 2308, if the threshold (e.g., regarding a likelihood of a second collision between the first vehicle and the pedestrian 504) is satisfied, the process can proceed to 2310. Otherwise, the process can return to 2302. At 2310, the process 2300 can comprise, based on the second collision being determined to be threshold likely to occur, facilitating (e.g., via the impact mitigation component 208) an impact mitigation action determined (e.g., via the impact mitigation component 208) to mitigate the second collision.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 116 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

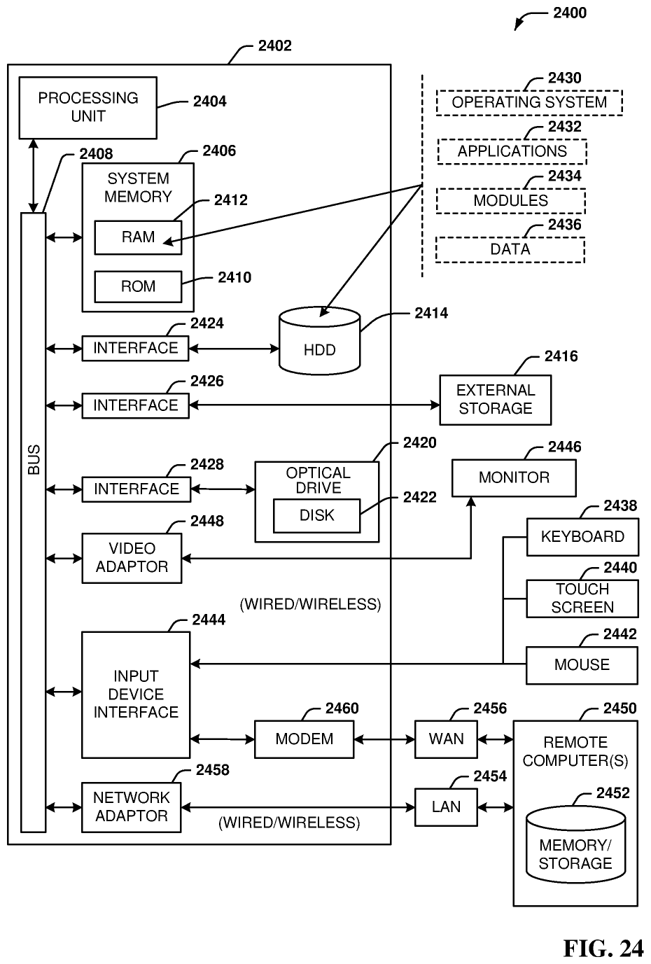

In order to provide additional context for various embodiments described herein, FIG. 24 and the following discussion are intended to provide a brief, general description of a suitable computing environment 2400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 24, the example environment 2400 for implementing various embodiments of the aspects described herein includes a computer 2402, the computer 2402 including a processing unit 2404, a system memory 2406 and a system bus 2408. The system bus 2408 couples system components including, but not limited to, the system memory 2406 to the processing unit 2404. The processing unit 2404 can be any of various commercially available processors, field-programmable gate array, AI accelerator application-specific integrated circuit, or other suitable processors. Dual microprocessors and other multi-processor architectures can also be employed as the processing unit 2404.

The system bus 2408 can be any of several types of bus structure that can further interconnect to a memory bus (with or without a memory controller), a peripheral bus, and a local bus using any of a variety of commercially available bus architectures. The system memory 2406 includes ROM 2410 and RAM 2412. A basic input/output system (BIOS) can be stored in a non-volatile memory such as ROM, erasable programmable read only memory (EPROM), EEPROM, which BIOS contains the basic routines that help to transfer information between elements within the computer 2402, such as during startup. The RAM 2412 can also include a high-speed RAM such as static RAM for caching data. It is noted that unified Extensible Firmware Interface(s) can be utilized herein.

The computer 2402 further includes an internal hard disk drive (HDD) 2414 (e.g., EIDE, SATA), one or more external storage devices 2416 (e.g., a magnetic floppy disk drive (FDD) 2416, a memory stick or flash drive reader, a memory card reader, etc.) and an optical disk drive 2420 (e.g., which can read or write from a CD-ROM disc, a DVD, a BD, etc.). While the internal HDD 2414 is illustrated as located within the computer 2402, the internal HDD 2414 can also be configured for external use in a suitable chassis (not shown). Additionally, while not shown in environment 2400, a solid-state drive (SSD) could be used in addition to, or in place of, an HDD 2414. The HDD 2414, external storage device(s) 2416 and optical disk drive 2420 can be connected to the system bus 2408 by an HDD interface 2424, an external storage interface 2426 and an optical drive interface 2428, respectively. The interface 2424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2412, including an operating system 2430, one or more application programs 2432, other program modules 2434 and program data 2436. All or portions of the operating system, applications, modules, and/or data can also be cached in the RAM 2412. The systems and methods described herein can be implemented utilizing various commercially available operating systems or combinations of operating systems.

Computer 2402 can optionally comprise emulation technologies. For example, a hypervisor (not shown) or other intermediary can emulate a hardware environment for operating system 2430, and the emulated hardware can optionally be different from the hardware illustrated in FIG. 24. In such an embodiment, operating system 2430 can comprise one virtual machine (VM) of multiple VMs hosted at computer 2402. Furthermore, operating system 2430 can provide runtime environments, such as the Java runtime environment or the .NET framework, for applications 2432. Runtime environments are consistent execution environments that allow applications 2432 to run on any operating system that includes the runtime environment. Similarly, operating system 2430 can support containers, and applications 2432 can be in the form of containers, which are lightweight, standalone, executable packages of software that include, e.g., code, runtime, system tools, system libraries and settings for an application.

Further, computer 2402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 2402, e.g., applied at the application execution level or at the operating system (OS) kernel level, thereby enabling security at any level of code execution.

A user can enter commands and information into the computer 2402 through one or more wired/wireless input devices, e.g., a keyboard 2438, a touch screen 2440, and a pointing device, such as a mouse 2442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2404 through an input device interface 2444 that can be coupled to the system bus 2408, but can be connected by other interfaces, such as a parallel port, an IEEE 1394 serial port, a game port, a USB port, an IR interface, a BLUETOOTH® interface, etc.

A monitor 2446 or other type of display device can be also connected to the system bus 2408 via an interface, such as a video adapter 2448. In addition to the monitor 2446, a computer typically includes other peripheral output devices (not shown), such as speakers, printers, etc.

The computer 2402 can operate in a networked environment using logical connections via wired and/or wireless communications to one or more remote computers, such as a remote computer(s) 2450. The remote computer(s) 2450 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory/storage device 2452 is illustrated. The logical connections depicted include wired/wireless connectivity to a local area network (LAN) 2454 and/or larger networks, e.g., a wide area network (WAN) 2456. Such LAN and WAN networking environments are commonplace in offices and companies, and facilitate enterprise-wide computer networks, such as intranets, all of which can connect to a global communications network, e.g., the Internet.

When used in a LAN networking environment, the computer 2402 can be connected to the local network 2454 through a wired and/or wireless communication network interface or adapter 2458. The adapter 2458 can facilitate wired or wireless communication to the LAN 2454. which can also include a wireless access point (AP) disposed thereon for communicating with the adapter 2458 in a wireless mode.

When used in a WAN networking environment, the computer 2402 can include a modem 2460 or can be connected to a communications server on the WAN 2456 via other means for establishing communications over the WAN 2456, such as by way of the Internet. The modem 2460, which can be internal or external and a wired or wireless device, can be connected to the system bus 2408 via the input device interface 2444. In a networked environment, program modules depicted relative to the computer 2402 or portions thereof, can be stored in the remote memory/storage device 2452. It will be appreciated that the network connections shown are example and other means of establishing a communications link between the computers can be used.

When used in either a LAN or WAN networking environment, the computer 2402 can access cloud storage systems or other network-based storage systems in addition to, or in place of, external storage devices 2416 as described above. Generally, a connection between the computer 2402 and a cloud storage system can be established over a LAN 2454 or WAN 2456 e.g., by the adapter 2458 or modem 2460, respectively. Upon connecting the computer 2402 to an associated cloud storage system, the external storage interface 2426 can, with the aid of the adapter 2458 and/or modem 2460, manage storage provided by the cloud storage system as it would other types of external storage. For instance, the external storage interface 2426 can be configured to provide access to cloud storage sources as if those sources were physically connected to the computer 2402.

The computer 2402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

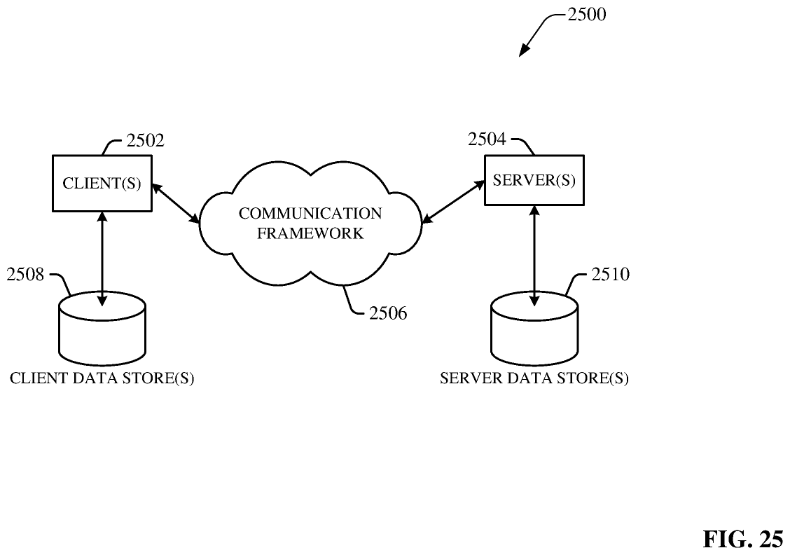

Referring now to FIG. 25, there is illustrated a schematic block diagram of a computing environment 2500 in accordance with this specification. The system 2500 includes one or more client(s) 2502, (e.g., computers, smart phones, tablets, cameras, PDA's). The client(s) 2502 can be hardware and/or software (e.g., threads, processes, computing devices). The client(s) 2502 can house cookie(s) and/or associated contextual information by employing the specification, for example.

The system 2500 also includes one or more server(s) 2504. The server(s) 2504 can also be hardware or hardware in combination with software (e.g., threads, processes, computing devices). The servers 2504 can house threads to perform transformations of media items by employing aspects of this disclosure, for example. One possible communication between a client 2502 and a server 2504 can be in the form of a data packet adapted to be transmitted between two or more computer processes wherein data packets may include coded analyzed headspaces and/or input. The data packet can include a cookie and/or associated contextual information, for example. The system 2500 includes a communication framework 2506 (e.g., a global communication network such as the Internet) that can be employed to facilitate communications between the client(s) 2502 and the server(s) 2504.

Communications can be facilitated via a wired (including optical fiber) and/or wireless technology. The client(s) 2502 are operatively connected to one or more client data store(s) 2508 that can be employed to store information local to the client(s) 2502 (e.g., cookie(s) and/or associated contextual information). Similarly, the server(s) 2504 are operatively connected to one or more server data store(s) 2510 that can be employed to store information local to the servers 2504. Further, the client(s) 2502 can be operatively connected to one or more server data store(s) 2510.

In one exemplary implementation, a client 2502 can transfer an encoded file, (e.g., encoded media item), to server 2504. Server 2504 can store the file, decode the file, or transmit the file to another client 2502. It is noted that a client 2502 can also transfer uncompressed file to a server 2504 and server 2504 can compress the file and/or transform the file in accordance with this disclosure. Likewise, server 2504 can encode information and transmit the information via communication framework 2506 to one or more clients 2502.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A system, comprising:
a memory that stores computer executable components; and
a processor that executes the computer executable components stored in the memory, wherein the computer executable components comprise:
an impact determination component that
   determines, based on a first location of a first vehicle, a second location of a second vehicle, and a speed differential between the first vehicle and the second vehicle, whether a first collision between the first vehicle and the second vehicle is threshold likely to occur, and
   determines, based on a third location of a pedestrian and the first collision being determined to be threshold likely to occur, whether a second collision between the first vehicle and the pedestrian is threshold likely to occur; and
an impact mitigation component that, based on the second collision being determined to be threshold likely to occur, facilitates an impact mitigation action determined to mitigate the second collision.
2. The system of any preceding clause, wherein the computer executable components further comprise:
a vehicle tracking component that determines the second location of the second vehicle and the speed differential between the first vehicle and the second vehicle; and
a pedestrian tracking component that determines the third location of the pedestrian.
3. The system of any preceding clause, wherein the impact mitigation action comprises an alert transmitted external to the first vehicle.
4. The system of any preceding clause, wherein the impact determination component further determines that the first collision between the first vehicle and the second vehicle is threshold likely to occur based on a type of the second vehicle.
5. The system of any preceding clause, wherein the computer executable components further comprise:
a pedestrian tracking component that determines, based on a facial recognition of the pedestrian, whether the pedestrian is threshold likely to be aware of the second collision, wherein the impact mitigation action determined to mitigate the second collision is further determined based on the facial recognition of the pedestrian.
6. The system of any preceding clause, wherein the computer executable components further comprise:
a communication component that, based on the second collision between the first vehicle and the pedestrian being determined to be threshold likely to occur, transmits alert data representative of an alert to a mobile device associated with the pedestrian, wherein the impact mitigation action comprises transmission of the alert.
7. The system of any preceding clause, wherein the mobile device displays a visual representation of the alert if a screen of the mobile device is unlocked when the alert data is received by the mobile device.
8. The system of any preceding clause, wherein the mobile device does not display a visual representation of the alert if a screen of the mobile device is locked when the alert data is received by the mobile device, and wherein the mobile device generates an audible alert based on the alert data.
9. The system of any preceding clause, wherein the computer executable components further comprise:
a communication component that, based on the second collision between the first vehicle and the pedestrian being determined to be threshold likely to occur, transmits alert data representative of an alert to a traffic signal applicable to the pedestrian.
10. The system of any preceding clause, wherein the pedestrian is operating a wheeled vehicle, wherein the impact determination component further determines whether the second collision between the first vehicle and the pedestrian is threshold likely to occur based on a trajectory of the wheeled vehicle.
11. The system of any preceding clause, wherein the computer executable components further comprise:
a pedestrian tracking component that, based on a signal applicable to the wheeled vehicle, determines a predicted trajectory applicable to the wheeled vehicle.
12. The system of any preceding clause, wherein the impact mitigation action determined to mitigate the second collision comprises moving the first vehicle from the first location to a fourth location, other than the first location, in response to a determination that the fourth location poses a lesser risk of the second collision occurring than that of the first location.
13. The system of any preceding clause, wherein the impact mitigation action determined to mitigate the second collision comprises holding the first vehicle at the first location in response to a determination that a fourth location, other than the first location, poses a heightened risk of the second collision occurring than that of the first location.
14. The system of any preceding clause, wherein the impact determination component further determines whether the first collision between the first vehicle and the second vehicle is threshold likely to occur based on a road condition applicable to the first vehicle or the second vehicle.
15. The system of any preceding clause, wherein the computer executable components further comprise:
a machine learning component that, generates, using machine learning applied to past first collusions other than the first collision or to past second collisions other than the second collision, generates a collision probability model, wherein the impact determination component further determines whether the first collision between the first vehicle and the second vehicle is threshold likely to occur, or whether the second collision between the first vehicle and the pedestrian is threshold likely to occur, using the collision probability model.
16. The system of clause 1 above with any set of combinations of the systems 2-15 above.
17. A non-transitory machine-readable medium, comprising executable instructions that, when executed by a processor, facilitate performance of operations, comprising:
determining, based on a first location of a first vehicle, a second location of a second vehicle, and a speed differential between the first vehicle and the second vehicle, whether a first collision between the first vehicle and the second vehicle is threshold likely to occur; determining, based on a third location of a pedestrian and the first collision being determined to be threshold likely to occur, whether a second collision between the first vehicle and the pedestrian is threshold likely to occur; and
based on the second collision being determined to be threshold likely to occur, facilitating an impact mitigation action determined to mitigate the second collision.
18. The non-transitory machine-readable medium of any preceding clause, wherein the operations further comprise:
transmitting, to a mobile device associated with a user of the second vehicle, alert data representative of an alert applicable to the first collision, wherein the mobile device renders a visual representation of the alert or an audible representation of the alert.
19. The non-transitory machine-readable medium of any preceding clause, wherein the impact mitigation action determined to mitigate the second collision comprises a lane change applicable to the first vehicle.
20. The non-transitory machine-readable medium of clause 17 above with any set of combinations of the non-transitory machine-readable mediums 18-19 above.
21. A method, comprising:
determining, by a system comprising a processor and based on a first location of a first vehicle, a second location of a second vehicle, and a speed differential between the first vehicle and the second vehicle, whether a first collision between the first vehicle and the second vehicle is threshold likely to occur;
determining, by the system and based on a third location of a pedestrian and the first collision being determined to be threshold likely to occur, whether a second collision between the first vehicle and the pedestrian is threshold likely to occur; and
based on the second collision being determined to be threshold likely to occur, facilitating, by the system, an impact mitigation action determined to mitigate the second collision.
22. The method of any preceding clause, wherein the impact mitigation action comprises an alert transmitted to a wearable device applicable to the pedestrian.

What is claimed is:

1. A system, comprising:
a memory that stores computer executable components; and
a processor that executes the computer executable components stored in the memory, wherein the computer executable components comprise:
an impact determination component that
determines, based on a first location of a first vehicle, a second location of a second vehicle, and a speed differential between the first vehicle and the second vehicle, whether a first collision between the first vehicle and the second vehicle is threshold likely to occur, and
determines, based on a third location of a pedestrian and the first collision being determined to be threshold likely to occur, whether a second collision between the first vehicle and the pedestrian is threshold likely to occur; and
an impact mitigation component that, based on the second collision being determined to be threshold likely to occur, facilitates an impact mitigation action determined to mitigate the second collision.

2. The system of claim 1, wherein the computer executable components further comprise:
a vehicle tracking component that determines the second location of the second vehicle and the speed differential between the first vehicle and the second vehicle; and
a pedestrian tracking component that determines the third location of the pedestrian.

3. The system of claim 1, wherein the impact mitigation action comprises an alert transmitted external to the first vehicle.

4. The system of claim 1, wherein the impact determination component further determines that the first collision between the first vehicle and the second vehicle is threshold likely to occur based on a type of the second vehicle.

5. The system of claim 1, wherein the computer executable components further comprise:
a pedestrian tracking component that determines, based on a facial recognition of the pedestrian, whether the pedestrian is threshold likely to be aware of the second collision, wherein the impact mitigation action determined to mitigate the second collision is further determined based on the facial recognition of the pedestrian.

6. The system of claim 1, wherein the computer executable components further comprise:
a communication component that, based on the second collision between the first vehicle and the pedestrian being determined to be threshold likely to occur, transmits alert data representative of an alert to a mobile device associated with the pedestrian, wherein the impact mitigation action comprises transmission of the alert.

7. The system of claim 6, wherein the mobile device displays a visual representation of the alert if a screen of the mobile device is unlocked when the alert data is received by the mobile device.

8. The system of claim 6, wherein the mobile device does not display a visual representation of the alert if a screen of the mobile device is locked when the alert data is received by the mobile device, and wherein the mobile device generates an audible alert based on the alert data.

9. The system of claim 1, wherein the computer executable components further comprise:
a communication component that, based on the second collision between the first vehicle and the pedestrian being determined to be threshold likely to occur, transmits alert data representative of an alert to a traffic signal applicable to the pedestrian.

10. The system of claim 1, wherein the pedestrian is operating a wheeled vehicle, wherein the impact determination component further determines whether the second collision between the first vehicle and the pedestrian is threshold likely to occur based on a trajectory of the wheeled vehicle.

11. The system of claim 10, wherein the computer executable components further comprise:
a pedestrian tracking component that, based on a signal applicable to the wheeled vehicle, determines a predicted trajectory applicable to the wheeled vehicle.

12. The system of claim 1, wherein the impact mitigation action determined to mitigate the second collision comprises moving the first vehicle from the first location to a fourth location, other than the first location, in response to a determination that the fourth location poses a lesser risk of the second collision occurring than that of the first location.

13. The system of claim 1, wherein the impact mitigation action determined to mitigate the second collision comprises holding the first vehicle at the first location in response to a determination that a fourth location, other than the first location, poses a heightened risk of the second collision occurring than that of the first location.

14. The system of claim 1, wherein the impact determination component further determines whether the first collision between the first vehicle and the second vehicle is threshold likely to occur based on a road condition applicable to the first vehicle or the second vehicle.

15. The system of claim 1, wherein the computer executable components further comprise:
a machine learning component that, generates, using machine learning applied to past first collusions other than the first collision or to past second collisions other than the second collision, generates a collision probability model, wherein the impact determination component further determines whether the first collision between the first vehicle and the second vehicle is threshold likely to occur, or whether the second collision between the first vehicle and the pedestrian is threshold likely to occur, using the collision probability model.

16. A non-transitory machine-readable medium, comprising executable instructions that, when executed by a processor, facilitate performance of operations, comprising:
determining, based on a first location of a first vehicle, a second location of a second vehicle, and a speed differential between the first vehicle and the second vehicle, whether a first collision between the first vehicle and the second vehicle is threshold likely to occur;
determining, based on a third location of a pedestrian and the first collision being determined to be threshold likely to occur, whether a second collision between the first vehicle and the pedestrian is threshold likely to occur; and
based on the second collision being determined to be threshold likely to occur, facilitating an impact mitigation action determined to mitigate the second collision.

17. The non-transitory machine-readable medium of claim 16, wherein the operations further comprise:
transmitting, to a mobile device associated with a user of the second vehicle, alert data representative of an alert applicable to the first collision, wherein the mobile device renders a visual representation of the alert or an audible representation of the alert.

18. The non-transitory machine-readable medium of claim 16, wherein the impact mitigation action determined to mitigate the second collision comprises a lane change applicable to the first vehicle.

19. A method, comprising:
determining, by a system comprising a processor and based on a first location of a first vehicle, a second location of a second vehicle, and a speed differential between the first vehicle and the second vehicle, whether a first collision between the first vehicle and the second vehicle is threshold likely to occur;
determining, by the system and based on a third location of a pedestrian and the first collision being determined to be threshold likely to occur, whether a second collision between the first vehicle and the pedestrian is threshold likely to occur; and
based on the second collision being determined to be threshold likely to occur, facilitating, by the system, an impact mitigation action determined to mitigate the second collision.

20. The method of claim 19, wherein the impact mitigation action comprises an alert transmitted to a wearable device applicable to the pedestrian.
